(19) United States
(12) Patent Application Publication
(10) Pub. No.: US 2002/0036452 A1
(43) Pub. Date: Mar. 28, 2002

(54) Electron emission device, cold cathode field emission device and method for the production thereof, and cold cathode field emission display and method for the production thereof

(76) Inventors: Masakazu Muroyama, Kanagawa (JP); Ichiro Saito, Kanagawa (JP); Kouji Inoue, Kanagawa (JP); Takao Yagi, Kanagawa (JP)

Correspondence Address: RADER , FISHMAN & GRAUER, P.L.L.C., 1233 20th Street, NW, Suite 501, Washington, DC, 20036, US

(21) Appl. No.: 09/739,739

(22) Filed: Dec. 20, 2000

(30) Foreign Application Priority Data
Dec. 21, 1999 (JP) P11-363135
Oct. 16, 2000 (JP) P2000-315452

(51) Int. Cl. H01J 1/00

(52) U.S. Cl. 313/310

(57) ABSTRACT

A cold cathode field emission device comprising (a) a cathode electrode formed on a supporting substrate, and (b) a gate electrode which is formed above the cathode electrode and has an opening portion, and further comprising (c) an electron emitting portion composed of a carbon film formed on a surface of a portion of the cathode electrode which portion is positioned in a bottom portion of the opening portion.

### BACKGROUND OF THE INVENTION AND RELATED ART STATEMENT

The present invention relates to an electron emission device for emitting electrons from a carbon film, a cold cathode field emission device having an electron emitting portion composed of a carbon film and a method for the production thereof, and it also relates to a cold cathode field emission display having such cold cathode field emission devices and a method for the production thereof.

In the fields of displays for use in television receivers and information terminals, studies have been made for replacing conventionally mainstream cathode ray tubes (CRT) with flat-panel displays which are to comply with demands for a decrease in thickness, a decrease in weight, a larger screen and a high fineness. Such flat panel displays include a liquid crystal display (LCD), an electroluminescence display (ELD), a plasma display panel (PDP) and a cold cathode field emission display (FED). Of these, a liquid crystal display is widely used as a display for an information terminal. For applying the liquid crystal display to a floor-type television receiver, however, it still has problems to be solved concerning a higher brightness and an increase in size. In contrast, a cold cathode field emission display uses cold cathode field emission devices (to be sometimes referred to as “field emission device” hereinafter) capable of emitting electrons from a solid into a vacuum on the basis of a quantum tunnel effect without relying on thermal excitation, and it is of great interest from the viewpoints of a high brightness and a low power consumption.

FIG. 17 shows an example of constitution of a cold cathode field emission display (to be sometimes referred to as “display” hereinafter) using field emission devices. The field emission device shown in FIG. 17 is a so-called Spindt type field emission device having a conical electron emitting portion. Such a field emission device comprises a cathode electrode 111 formed on a supporting substrate 110, an insulating layer 112 formed on the supporting substrate 110 and the cathode electrode 111, a gate electrode 113 formed on the insulating layer 112, an opening portion 114 formed in the gate electrode 113 and the insulating layer 112, and a conical electron emitting portion 115 formed on the cathode electrode 111 positioned in a bottom portion of the opening portion 114. Generally, the cathode electrode 111 and the gate electrode 113 are formed in the form of a stripe each in directions in which projection images of these two electrodes cross each other at right angles. Generally, a plurality of field emission devices are arranged in a region (corresponding to one pixel, the region will be called an “overlapped region” hereinafter) where the projection images of the above two electrodes overlap. Further, generally, such overlapped regions are arranged in the form of a matrix within an effective field (which works as an actual display portion) of a cathode panel CP.

An anode panel AP comprises a substrate 30, a fluorescent layer 31 which is formed on the substrate 30 and has a predetermined pattern, and an anode electrode 33 formed thereon. One pixel is constituted of a group of the field emission devices arranged in the overlapped region of the cathode electrode 111 and the gate electrode 113 on the cathode panel side and the fluorescent layer 31 which is opposed to the above group of the field emission devices and is on the anode panel AP. In the effective field, such pixels are arranged on the order of hundreds of thousands to several millions. On the substrate 30 between one fluorescent layer 31 and another fluorescent layer 31, a black matrix 32 is formed.

The anode panel AP and the cathode panel CP are arranged such that the field emission devices and the fluorescent layers are opposed to each other, and the anode panel AP and the cathode panel CP are bonded to each other in their circumferential portions through a frame 34, whereby the display is produced. In an ineffective field (ineffective field of the cathode panel CP in the example shown in FIG. 17) which surrounds the effective field and where a peripheral circuit for selecting pixels is formed, a through hole 36 for vacuuming is provided, and a tip tube 37 is connected to the through hole 36 and sealed after vacuuming. That is, a space surrounded by the anode panel AP, the cathode panel CP and the frame 34 is in a vacuum state.

A relatively negative voltage is applied to the cathode electrode 111 from a scanning circuit 40, a relatively positive voltage is applied to the gate electrode 113 from a control circuit 41, and a positive voltage having a higher level than the voltage applied to the gate electrode 113 is applied to the anode electrode 33 from the accelerating power source 42. When such a display is used for displaying on its screen, a scanning signal is inputted to the cathode electrode 111 from the scanning circuit 40, and a video signal is inputted to the gate electrode 113 from the control circuit 41. Due to an electric field generated when a voltage is applied between the cathode electrode 111 and the gate electrode 113, electrons are emitted from the electron emitting portion 115 on the basis of a quantum tunnel effect, and the electrons are attracted toward the anode electrode 33 and collide with the fluorescent layer 31. As a result, the fluorescent layer 31 is excited to emit light, and a desired image can be obtained. That is, the working of the display is controlled, in principle, by a voltage applied to the gate electrode 113 and a voltage applied to the electron emitting portion 115 through the cathode electrode 111.

In the above display constitution, it is effective to sharpen the top end portion of the electron emitting portion for attaining a large current of emitted electrons at a low driving voltage, and from this viewpoint, the electron emitting portion 115 of the above Spindt type field emission device can be said to have excellent performances. However, the formation of the conical electron emitting portion 115 requires advanced processing techniques, and with an increase in the area of the effective field, it is beginning to be difficult to form the electron emitting portions 115 uniformly all over the effective field since the number of the electron emitting portions 115 totals up to tens of millions in some cases.

There has been therefore proposed a so-called flat-surface type field emission device which uses a flat electron emitting portion exposed in a bottom portion of an opening portion without using the conical electron emitting portion. The electron emitting portion of the flat-surface type field emission device is formed on a cathode electrode, and it is composed of a material having a lower work function than a material constituting the cathode electrode for achieving a high current of emitted electrons even if the electron emitting portion is flat. In recent years, it has been proposed to use a carbon material as the above material.

For example, in Lecture No. 15p-P-13 on page 480 of preprints of No. 59 Applied Physics Society Lectures (1998), a DLC (diamond-like carbon) thin film is proposed. When a carbon material is formed into a thin film, a method for processing (patterning) the thin film is required. As a patterning method therefor, for example, Lecture No. 16p-N-11 on page 489 of the above preprints (1998) proposes an ECR plasma processing of a diamond thin film with oxygen gas as an etching gas. Generally, an SiO₂-containing material is used as a mask for etching in the plasma processing of a diamond thin film.

Further, in Lecture No. 2p-H-6 on page 631 of preprints of No. 60 Applied Physics Society Lectures (1999) (to be referred to as Literature-1), there is disclosed a flat-surface-structured electron emitter obtained by scratch-processing a surface of a titanium thin film formed on a quartz substrate by an electron beam deposition method, with a diamond powder, then patterning the titanium thin film to form a several μm gap in a central portion, and then, forming a non-doped diamond thin film on the titanium thin film. In Lecture No. 2p-H-11 on page 632 of preprints of No. 60 Applied Physics Society Lectures (1999) (to be referred to as Literature-2), there is disclosed a method in which a carbon nano-tube is formed on a quartz glass provided with a metal cross line.

When a carbon film such as DLC is plasma-etched with oxygen gas with using a resist layer as an etching mask, a deposition product of a (CHₓ)- or (CFₓ)-based carbon polymer is generated as a reaction byproduct in the etching reaction system. When a deposition product is generated in the etching reaction system in the plasma etching, generally, the deposition product is formed on a side wall surface of a resist layer which side wall surface has a low ion incidence probability or is formed on a processed end surface of a material being etched, to form a so-called side wall protective film, and it contributes to accomplishment of the form obtained by anisotropic processing a material being etched. When oxygen gas is used as an etching gas, however, the side wall protective film composed of the carbon polymer is removed by oxygen gas upon the formation thereof. Further, when oxygen gas is used as an etching gas, the resist layer is worn to a great extent. For these reasons, in the conventional oxygen plasma process of a diamond thin film, the pattern transfer difference of the diamond thin film from the mask is large, and an anisotropic processing is also difficult.

Further, in techniques disclosed in Literature-1 and Literature-2, a carbon film is formed on a metal thin layer. However, the carbon film is formed in any portion of the metal thin layer, so that it cannot be said that it is practical to apply these techniques, for example, to the production of the cold cathode field emission device. It is also difficult to pattern a carbon film for forming the carbon film as desired, as has been described above.

### OBJECT AND SUMMARY OF THE INVENTION

It is therefore an object of the present invention to provide an electron emission device having a carbon film reliably formed in a desired portion of a conductive layer, a cold cathode field emission device having a carbon film reliably formed in a desired portion of a cathode electrode and a method for the production thereof. It is another object of the present invention to provide a cold cathode field emission display having such cold cathode field emission devices incorporated and a method for the production thereof.

The electron emission device of the present invention for achieving the above object has an electron emitting portion comprising;

(a) a conductive layer with a carbon film selective-growth region formed on a surface thereof, and

(b) an electron emitting portion composed of a carbon film formed on the carbon film selective-growth region.

According to a first aspect of the present invention for achieving the above object, there is provided a cold cathode field emission display to which the electron emission device of the present invention is incorporated. That is, the cold cathode field emission display according to the first aspect of the present invention comprises a plurality of pixels,

each pixel comprising a cold cathode field emission device, an anode electrode and a fluorescent layer, the anode electrode and the fluorescent layer being formed on a substrate so as to be opposed to the cold cathode field emission device, and

the cold cathode field emission device comprising;

(a) a conductive layer with a carbon film selective-growth region formed on a surface thereof, and

(b) an electron emitting portion composed of a carbon film formed on the carbon film selective-growth region.

For allowing the carbon film to emit electrons in the electron emission device or the cold cathode field emission display according to the first aspect of the present invention, it is sufficient to constitute a state where the carbon film is placed in a proper electric field (for example, an electric field having an intensity of approximately 10⁶ volts/cm).

A cold cathode field emission device according to a first aspect of the present invention for achieving the above object of the present invention comprises;

(a) a cathode electrode formed on a supporting substrate, and

(b) a gate electrode which is formed above the cathode electrode and has an opening portion,

and further comprises;

(c) an electron emitting portion composed of a carbon film formed on a surface of a portion of the cathode electrode which portion is positioned in a bottom portion of the opening portion.

According to a second aspect of the present invention for achieving the above object, there is provided a cold cathode field emission display in which the cold cathode field emission device according to the first aspect of the present invention is incorporated. That is, the cold cathode field emission display according to the second aspect of the present invention comprises a plurality of pixels,

each pixel comprises a cold cathode field emission device, an anode electrode and a fluorescent layer, the anode electrode and the fluorescent layer being formed on a substrate so as to be opposed to the cold cathode field emission device, and

the cold cathode field emission device comprises;

(a) a cathode electrode formed on a supporting substrate, and

(b) a gate electrode which is formed above the cathode electrode and has an opening portion, and further comprises;

(c) an electron emitting portion composed of a carbon film formed on a surface of a portion of the cathode electrode which portion is positioned in a bottom portion of the opening portion.

In the cold cathode field emission device according to the first aspect of the present invention or the cold cathode field emission display according to the second aspect of the present invention, preferably, the cathode electrode is composed of copper (Cu), silver (A) or gold (Au) for decreasing the resistance of the cathode electrode.

In the cold cathode field emission device according to the first aspect of the present invention or the cold cathode field emission display according to the second aspect of the present invention, it is preferred to employ a constitution in which an insulating layer is formed on the supporting substrate and the cathode electrode, and a second opening portion communicating with the opening portion formed in the gate electrode is formed in the insulating layer. However, the present invention shall not be limited to the above constitution. For example, there may be employed a structure in which a metal layer (for example, a sheet or a stripe-like member composed of a metal) constituting the gate electrode having opening portions is arranged above the electron emitting portion with a gate electrode supporting member.

The cold cathode field emission device according to a second aspect of the present invention for achieving the above object comprises;

(a) a cathode electrode formed on a supporting substrate, and

(b) a gate electrode which is formed above the cathode electrode and has an opening portion,

and further comprises;

(c) a carbon film selective-growth region formed at least on a surface of a portion of the cathode electrode which portion is positioned in a bottom portion of the opening portion, and

(d) an electron emitting portion composed of a carbon film formed on the carbon film selective-growth region.

According to a third aspect of the present invention for achieving the above object, there is provided a cold cathode field emission display in which the cold cathode field emission device according to the second aspect of the present invention is incorporated. That is, the cold cathode field emission display according to the third aspect of the present invention comprises a plurality of pixels,

each pixel comprises a cold cathode field emission device, an anode electrode and a fluorescent layer, the anode electrode and the fluorescent layer being formed on a substrate so as to be opposed to the cold cathode field emission device, and

the cold cathode field emission device comprises;

(a) a cathode electrode formed on a supporting substrate,

(b) a gate electrode which is formed above the cathode electrode and has an opening portion,

(c) a carbon film selective-growth region formed at least on a surface of a portion of the cathode electrode which portion is positioned in a bottom portion of the opening portion, and

(d) an electron emitting portion composed of a carbon film formed on the carbon film selective-growth region.

In the cold cathode field emission device according to the first aspect or second aspect of the present invention, electrons are emitted from the electron emitting portion composed of the carbon film on the basis of an electric field (for example, an electric field having an intensity of approximately 10⁶ volts/cm) generated by applying a voltage to the cathode electrode and the gate electrode. In the cold cathode field emission display according to the second aspect or third aspect of the present invention, electrons are emitted from the electron emitting portion composed of the carbon film on the basis of an electric field (for example, an electric field having an intensity of approximately 10⁶ volts/cm) generated by applying a voltage to the cathode electrode and the gate electrode, and these electrons are allowed to collide with the fluorescent layer, whereby an image can be obtained.

In the electron emission device of the present invention, the cold cathode field emission device according to the second aspect of the present invention or the cold cathode field emission display according to the first aspect or the third aspect of the present invention, the carbon film selective-growth region is preferably that portion of the conductive layer or the cathode electrode onto a surface of which portion metal particles adhere, or that portion of the conductive layer or the cathode electrode on a surface of which portion a metal thin layer or an organometallic compound thin layer is formed. For making the selective growth of the carbon film on the carbon film selective-growth region more reliable, desirably, the surface of the carbon film selective-growth region has sulfur (S), boron (B) or phosphorus (P) adhering thereto. It is considered that the above materials work as a kind of a catalyst, and the presence of such materials can improve the carbon film more in the property of selective growth.

In the cold cathode field emission device according to the second aspect of the present invention or the cold cathode field emission display according to the third aspect of the present invention, it is sufficient that the carbon film selective-growth region should be formed on the surface of the portion of the cathode electrode which portion is positioned in the bottom portion of the opening portion. The carbon film selective-growth region may be formed so as to extend from the portion of the cathode electrode which portion is positioned in the bottom portion of the opening portion to a surface of a portion of the cathode electrode which portion is located in other than the bottom portion of the opening portion. Further, the carbon film selective-growth region may be formed on the entirety of the surface of the portion of the cathode electrode which portion is positioned in the bottom portion of the opening portion, or it may be formed in part of the above portion.

In the cold cathode field emission device according to the second aspect of the present invention or the cold cathode field emission display according to the third aspect of the present invention, there may be employed a constitution in which an insulating layer is formed on the supporting substrate and the cathode electrode, a second opening portion communicating with the opening portion (to be sometimes referred to as “first opening portion” hereinafter) formed in the gate electrode is formed in the insulating layer, and the carbon film is positioned in a bottom portion of the second opening portion. The first opening portion and the second opening portion have a one-to-one correspondence relationship. That is, one second opening portion is formed per first opening portion. The cold cathode field emission device according to the second aspect of the present invention or the cold cathode field emission display according to the third aspect of the present invention shall not be limited to the above structure. For example, there may be employed a structure in which a metal layer (for example, a sheet or a stripe-like member composed of a metal) constituting the gate electrode having opening portions is arranged above the electron emitting portion with a gate electrode supporting member.

A method for the production of a cold cathode field emission device, according to a first aspect of the present invention for achieving the above object, comprises the steps of;

(A) forming a cathode electrode on a supporting substrate,

(B) forming an insulating layer on the supporting substrate and the cathode electrode,

(C) forming a gate electrode having an opening portion on the insulating layer,

(D) forming, in the insulating layer, a second opening portion communicating with the opening portion formed in the gate electrode,

(E) forming a carbon film selective-growth region on a surface of a portion of the cathode electrode which portion is positioned in a bottom portion of the second opening portion (carbon film selective-growth region formation step), and

(F) forming a carbon film on the carbon film selective-growth region.

The method for the production of a cold cathode field emission display, according to a first aspect of the present invention for achieving the above object, is a production method in which the method for the production of a cold cathode field emission device, according to the first aspect of the present invention, is applied to the method for the production of a cold cathode field emission display. That is, the above method according to the first aspect of the present invention comprises arranging a substrate having an anode electrode and a fluorescent layer formed thereon and a supporting substrate having a cold cathode field emission device formed thereon, such that the fluorescent layer and the cold cathode field emission device are opposed to each other, and bonding the substrate and the supporting substrate in circumferential portions thereof,

wherein the cold cathode field emission device is produced by a method comprising the steps of;

(A) forming a cathode electrode on a supporting substrate,

(B) forming an insulating layer on the supporting substrate and the cathode electrode,

(C) forming a gate electrode having an opening portion on the insulating layer,

(D) forming, in the insulating layer, a second opening portion communicating with the opening portion formed in the gate electrode,

(E) forming a carbon film selective-growth region on a surface of a portion of the cathode electrode which portion is positioned in a bottom portion of the second opening portion (carbon film selective-growth region formation step), and

(F) forming a carbon film on the carbon film selective-growth region.

In the method for the production of a cold cathode field emission device according to the first aspect of the present invention or the method for the production of a cold cathode field emission display according to the first aspect of the present invention (these production methods will be sometimes generally referred to as “production method according to the first aspect of the present invention” hereinafter), the carbon film selective-growth region formation step may comprise the steps of forming a mask layer with a surface of the cathode electrode which surface is exposed in a central portion of the bottom portion of the second opening portion (i.e., forming a mask layer at least on a side wall of the second opening portion), and then allowing metal particles to adhere onto, or forming a metal thin layer or an organometallic compound thin layer on, the mask layer and the exposed surface of the cathode electrode.

The above mask layer can be formed, for example, by a method in which a resist material layer or a hard mask material layer is formed on the entire surface and making a hole in a portion of the resist material layer or the hard mask material layer which portion is positioned in the central portion of the bottom portion of the second opening portion by lithography. In a state where the mask layer covers part of the cathode electrode which part is positioned in the bottom portion of the second opening portion, the side wall of the second opening portion, the side wall of the first opening portion, the insulating layer and the gate electrode, the carbon film selective-growth region is formed on the surface of the cathode electrode which surface is positioned in the central portion of the bottom portion of the second opening portion. Therefore, short-circuiting between the cathode electrode and the gate electrode through the metal particles or the metal thin layer can be reliably prevented. In some cases, the mask layer may cover the gate electrode alone. Otherwise, the mask layer may cover only the gate electrode in the vicinity of the first opening portion, or the mask layer may cover the gate electrode in the vicinity of the first opening portion and the side walls of the first and second opening portions. In these cases, a carbon film may be formed on the gate electrode depending upon an electrically conductive material constituting the gate electrode. However, electrons are not emitted when the above carbon film is not placed in a high-intensity electric field. It is preferred to remove the mask layer before the formation of the carbon film on the carbon film selective-growth region.

In the production method according to the first aspect of the present invention, the method for forming the gate electrode having the first opening portion on the insulating layer includes a method in which an electrically conductive material layer for a gate electrode is formed on the insulating layer; then, a patterned first mask material layer is formed on the electrically conductive material layer; the electrically conductive material layer is etched with using the first mask material layer as an etching mask, to pattern the electrically conductive material layer; then, the first mask material layer is removed; then, a patterned second mask material layer is formed on the electrically conductive material layer and the insulating layer; and the electrically conductive material layer is etched with using the second mask material layer as an etching mask, to form the first opening portion, and a method in which the gate electrode having the first opening portion is directly formed, for example, by a screen printing method. In these cases, the method for forming, in the insulating layer, the second opening portion communicating with the first opening portion formed in the gate electrode may be a method in which the insulating layer is etched with using the above second mask material layer as an etching mask, or may be a method in which the insulating layer is etched with using, as an etching mask, the first opening portion formed in the gate electrode. The first opening portion and the second opening portion have a one-to-one correspondence relationship. That is, one second opening portion is formed per first opening portion.

The method for the production of a cold cathode field emission device, according to a second aspect of the present invention for achieving the above object comprises the steps of;

(A) forming a cathode electrode on a supporting substrate,

(B) forming a carbon film selective-growth region on a surface of the cathode electrode (carbon film selective-growth region formation step),

(C) forming a carbon film on the carbon film selective-growth region, and

(D) forming a gate electrode having an opening portion above the carbon film.

The method for the production of a cold cathode field emission display, according to a second aspect of the present invention for achieving the above object is a method in which the method for the production of a cold cathode field emission device, according to the second aspect of the present invention, is applied to the method for the production of a cold cathode field emission display. That is, the above method according to the second aspect of the present invention comprises arranging a substrate having an anode electrode and a fluorescent layer formed thereon and a supporting substrate having a cold cathode field emission device formed thereon, such that the fluorescent layer and the cold cathode field emission device are opposed to each other, and bonding the substrate and the supporting substrate in circumferential portions thereof,

wherein the cold cathode field emission device is produced by a method comprising the steps of;

(A) forming a cathode electrode on a supporting substrate,

(B) forming a carbon film selective-growth region on a surface of the cathode electrode (carbon film selective-growth region formation step),

(C) forming a carbon film on the carbon film selective-growth region, and

(D) forming a gate electrode having an opening portion above the carbon film.

The method for the production of a cold cathode field emission device, according to a third aspect of the present invention for achieving the above object comprises the steps of;

(A) forming a cathode electrode on a supporting substrate,

(B) forming a carbon film selective-growth region on a surface of the cathode electrode (carbon film selective-growth region formation step),

(C) forming a gate electrode having an opening portion above the carbon film selective-growth region, and

(D) forming a carbon film on the carbon film selective-growth region.

The method for the production of a cold cathode field emission display, according to a third aspect of the present invention for achieving the above object is a method in which the method for the production of a cold cathode field emission device, according to the third aspect of the present invention, is applied to the method for the production of a cold cathode field emission display. That is, the above method according to the third aspect of the present invention comprises arranging a substrate having an anode electrode and a fluorescent layer formed thereon and a supporting substrate having a cold cathode field emission device formed thereon, such that the fluorescent layer and the cold cathode field emission device are opposed to each other, and bonding the substrate and the supporting substrate in circumferential portions thereof,

wherein the cold cathode field emission device is produced by a method comprising the steps of;

(A) forming a cathode electrode on a supporting substrate,

(B) forming a carbon film selective-growth region on a surface of the cathode electrode (carbon film selective-growth region formation step),

(C) forming a gate electrode having an opening portion above the carbon film selective-growth region, and

(D) forming a carbon film on the carbon film selective-growth region.

In the method for the production of a cold cathode field emission device according to the second aspect of the present invention or the method for the production of a cold cathode field emission display according to the second aspect of the present invention (these production methods will be sometimes generally referred to as “production method according to the second aspect of the present invention” hereinafter), there may be employed a constitution in which the above step (C) is followed by forming an insulating layer on the entire surface, and the above step (D) is followed by forming, in the insulating layer, a second opening portion communicating the opening portion formed in the gate electrode and exposing the carbon film in a bottom portion of the second opening portion. In the method for the production of a cold cathode field emission device according to the third aspect of the present invention or the method for the production of a cold cathode field emission display according to the third aspect of the present invention (these production methods will be sometimes generally referred to as “production method according to the third aspect of the present invention” hereinafter), there may be employed a constitution in which the above step (B) is followed by forming an insulating layer on the entire surface, and the above step (C) is followed by forming, in the insulating layer, a second opening portion communicating with the opening portion formed in the gate electrode and exposing the carbon film selective-growth region in a bottom portion of the second opening portion. In these cases, the method for forming the gate electrode having the first opening portion on the insulating layer includes a method in which an electrically conductive material layer for a gate electrode is formed on the insulating layer; then, a patterned first mask material layer is formed on the electrically conductive material layer; the electrically conductive material layer is etched with using the first mask material layer as an etching mask, to pattern the electrically conductive material layer; then, the first mask material layer is removed; then, a patterned second mask material layer is formed on the electrically conductive material layer and the insulating layer; and the electrically conductive material is etched with using the second mask material layer as an etching mask, to form the first opening portion, and a method in which the gate electrode having the first opening abortion is directly formed, for example, by a screen printing method. In these cases, the method for forming, in the insulating layer, the second opening portion communicating the first opening portion formed in the gate electrode may be a method in which the insulating layer is etched with using the above second mask material layer as an etching mask, or a method in which the insulating layer is etched with using, as an etching mask, the first opening portion formed in the gate electrode. The first opening portion and the second opening portion have a one-to-one correspondence relationship. That is, one second opening portion is formed per first opening portion.

Alternatively, in the production method according to the second aspect of the present invention or the production method according to the third aspect of the present invention, the step of forming the gate electrode having the opening portion above the carbon film or the step of forming the gate electrode having the opening portion above the carbon film selective-growth region may comprise the steps of forming a stripe-shaped gate electrode supporting member composed of an insulating material on the supporting substrate and arranging the gate electrode composed of a stripe-shaped or sheet-shaped metal layer having a plurality of opening portions formed therein, above the carbon film or the carbon film selective-growth region such that the metal layer is in contact with top surfaces of the gate electrode supporting members.

In the production method according to the first, second or third aspect of the present invention (these production methods will be sometimes generally referred to as “the method of the present invention” hereinafter), preferably, the carbon film selective-growth region formation step comprises the step of allowing metal particles to adhere onto, or forming a metal thin layer or an organometallic compound thin layer on, the surface of the portion of the cathode electrode in which portion the carbon film selective-growth region is to be formed, whereby there is formed the carbon film selective-growth region constituted of the portion of the cathode electrode which portion has the surface onto which the metal particles adhere or on which the metal thin layer or the organometallic compound thin layer is formed. In this case, for making more reliable the selective growth of the carbon film on the carbon film selective-growth region, desirably, sulfur (S), boron (B) or phosphorus (P) is allowed to adhere onto the surface of the carbon film selective-growth region, whereby the carbon film can be more improved in the property of selective growth. The method for allowing sulfur, boron or phosphorus to adhere onto the surface of the carbon film selective-growth region includes, for example, a method in which a compound layer composed of a compound containing sulfur, boron or phosphorus is formed on the surface of the carbon film selective-growth region, and then, the compound layer is heat-treated to decompose the compound constituting the compound layer, whereby sulfur, boron or phosphorus is retained on the surface of the carbon film selective-growth region. The sulfur-containing compound includes thionaphthene, thiophthene and thiophene. The boron-containing compound includes triphenylboron. The phosphorus-containing compound includes triphenylphosphine. Otherwise, for making more reliable the selective growth of the carbon film on the carbon film selective-growth region, after the metal particles are allowed to adhere onto, or the metal thin layer or the organometallic compound thin layer is formed on, the surface of the cathode electrode, it is preferred to remove a metal oxide (so-called natural oxide film) on the surface of each metal particle or on the surface of the metal thin layer or the organometallic compound thin layer. The metal oxide on the surface of each metal particle or on the surface of the metal thin layer or the organometallic compound thin layer is preferably removed, for example, by plasma reduction treatment based on, in a hydrogen gas atmosphere, a microwave plasma method, a transformer-coupled plasma method, an inductively coupled plasma method, an electron cyclotron resonance plasma method or an RF plasma method; by sputtering in an argon gas atmosphere; or by washing, for example, with an acid such as hydrofluoric acid or a base. In the production method according to the third aspect of the present invention, preferably, the step of allowing sulfur, boron or phosphorus to adhere onto the surface of the carbon film selective-growth region, or the step of removing the metal oxide on the surface of each metal particle or on the surface of the metal thin layer or the organometallic compound thin layer is carried out after the formation of the gate electrode having the opening portion and before the formation of the carbon film on the carbon film selective-growth region. In the production of the electron emission device of the present invention, further, the above-explained various steps can be applied to the surface of the portion of the conductive layer in which portion the carbon film selective-growth region is to be formed. “The portion of the conductive layer in which portion the carbon film selective-growth region is to be formed” will be sometimes simply referred to as “conductive layer portion”, and “the portion of the cathode electrode in which portion the carbon film selective-growth region is to be formed” will be sometimes simply referred to as “cathode electrode portion”, hereinafter.

The method for allowing the metal particles to adhere onto the surface of the conductive layer portion or the cathode electrode portion includes, for example, a method in which, in a state where a region other than the region where the carbon film selective-growth region is to be formed in the conductive layer or the cathode electrode is covered with a proper material (for example, a mask layer), a layer composed of a solvent and the metal particles is formed on the surface of the conductive layer portion or the cathode electrode portion, and then, the solvent is removed while retaining the metal particles. Alternatively, the step of allowing the metal particles to adhere onto the surface of the conductive layer portion or the cathode electrode portion includes, for example, a method in which, in a state where a region other than the region where the carbon film selective-growth region is to be formed in the conductive layer or the cathode electrode is covered with a proper material (for example, a mask layer), metal compound particles containing metal atoms constituting the metal particles are allowed to adhere onto the surface of the conductive layer or the cathode electrode, and then the metal compound particles are heated to decompose them, whereby there is obtained the carbon film selective-growth region constituted of the portion of the conductive layer or the cathode electrode which portion has the surface onto which the metal particles adhere. In the above method, specifically, a layer composed of a solvent and metal compound particles is formed on the surface of the conductive layer portion or the cathode electrode portion, and the solvent is removed while retaining the metal compound particles. The above metal compound particles are preferably composed of at least one material selected from the group consisting of halides (for example, iodides, chlorides, bromides, etc.), oxides and hydroxides of the metal and organic metal compounds for constituting the metal particles. In the above methods, the material (for example, mask layer) covering the region other than the region where the carbon film selective-growth region is to be formed in the conductive layer or the cathode electrode is removed at a proper stage.

Although differing depending upon materials for constituting the metal thin layer, the method for forming the metal thin layer on the surface of the conductive layer portion or the cathode electrode portion is selected, for example, from a plating method such as an electroplating method and an electroless plating method, a chemical vapor deposition method (CVD method) including an MOCVD method, a physical vapor deposition method (PVD method) and a method of pyrolyzing an organometallic compound, in a state where a region other than the region where the carbon film selective-growth region is to be formed in the conductive layer or the cathode electrode is covered with a proper material. The physical vapor deposition method includes (a) vacuum deposition methods such as an electron beam heating method, a resistance heating method and a flash deposition method, (b) a plasma deposition method, (c) sputtering methods such as a bipolar sputtering method, a DC sputtering method, a DC magnetron sputtering method, a high-frequency sputtering method, a magnetron sputtering method, an ion beam sputtering method and a bias sputtering method, and (d) ion plating methods such as a DC (direct current) method, an RF method, a multi-cathode method, an activating reaction method, an electric field deposition method, a high-frequency ion plating method and a reactive ion-plating method.

In the electron emission device of the present invention, the cold cathode field emission device according to the second aspect of the present invention, the cold cathode field emission display according to the third aspect of the present invention or the production method according to any one of the first to third aspects of the present invention, preferably, the metal particles or the metal thin layer for forming the carbon film selective-growth region are/is composed of at least one metal selected from the group consisting of molybdenum (Mo), nickel (Ni), titanium (Ti), chromium (Cr), cobalt (Co), tungsten (W), zirconium (Zr), tantalum (Ta), iron (Fe), copper (Cu), platinum (Pt), zinc (Zn), cadmium (Cd), mercury (Hg), germanium (Ge), tin (Sn), lead (Pb), bismuth (Bi), silver (Ag), gold (Au), indium (In) and thallium (Tl).

In the electron emission device of the present invention, the cold cathode field emission device according to the second aspect of the present invention and the cold cathode field emission display according to the third aspect of the present invention, the organometallic compound thin layer constituting the carbon film selective-growth region can be formed from an organometallic compound containing at least one element selected from the group consisting of zinc (Zn), tin (Sn), aluminum (Al), lead (Pb), nickel (Ni) and cobalt (Co). Further, it is preferably composed of a complex compound. Examples of the ligand constituting the above complex compound include acetylacetone, hexafluoroacetylacetone, dipivaloylmethane and cyclopentadienyl. The organometallic compound thin layer may contain part of a decomposition product from an organometallic compound.

In the production method according to any one of the first to third aspects of the present invention, the step of forming the organometallic compound thin layer on the surface of the cathode electrode portion can be the step of forming a layer composed of an organometallic compound solution on the cathode electrode portion, or the step of sublimating an organometallic compound to deposit it on the cathode electrode portion. In these cases, the organometallic compound thin layer constituting the carbon film selective-growth region is preferably composed of an organometallic compound containing at least one element selected from the group consisting of zinc (Zn), tin (Sn), aluminum (Al), lead (Pb), nickel (Ni) and cobalt (Co). Further, it is preferably composed of a complex compound. Examples of the ligand constituting the above complex compound include acetylacetone, hexafluoroacetylacetone, dipivaloylmethane and cyclopentadienyl. The organometallic compound thin layer may contain part of a decomposition product from an organometallic compound.

In the cold cathode field emission device according to the second aspect of the present invention or the cold cathode field emission display according to the third aspect of the present invention, the metal particles adhering onto the surface of the cathode electrode portion may have an acicular (needle-like) form. In this case, the acicular metal particles are preferably composed of at least one metal selected from the group consisting of copper (Cu), iron (Fe), tungsten (W), tantalum (Ta), titanium (Ti) and zirconium (Zr). When the carbon film selective-growth region is formed of such metal particles having an acicular form, the carbon film formed thereon has protrusions. As a result, there can be obtained cold cathode field emission devices having high electron emission efficiency, and the cold cathode field emission devices having high electron emission efficiency can be obtained without depending upon conditions of forming the carbon film.

In the production method according to any one of the first to third aspects of the present invention, the step of allowing the metal particles to adhere onto the surface of the cathode electrode portion can be the step of sublimating a metal compound to deposit acicular metal particles composed of a metal constituting the metal compound on the surface of the cathode electrode portion. In this case, the acicular metal particles are preferably composed of at least one metal selected from the group consisting of copper (Cu), iron (Fe), tungsten (W), tantalum (Ta), titanium (Ti) and zirconium (Zr). The metal compound is preferably a halide of the above metal, such as chloride, bromide, fluoride or iodide of the above metal.

In the present invention, the carbon film includes a graphite thin film, an amorphous carbon thin film, a diamond-like carbon thin film and a fullerene thin film. The method for forming the carbon film includes CVD methods based on a microwave plasma method, a transformer-coupled plasma method, an inductively coupled plasma method, an electron cyclotron resonance plasma method, an RF plasma method, a helicon wave plasma CVD method and a capacitively coupled plasma CVD method, and a CVD method using a diode parallel plate plasma enhanced CVD system. The form of the carbon film includes the form of a thin film, and it also includes the form of a carbon whisker and the form of a nano-tube (including hollow and solid tubes). The source gas for forming the carbon film includes carbon gases such as methane (CH₄), ethane (C₂H₆), propane (C₃H₈), butane (C₄H₁₀), ethylene (C₂H₄) and acetylene (C₂H₂), a mixture of any members of these carbon gases and a mixture of any one of members of these carbon gases with hydrogen gas. Further, a gas prepared by gasifying methanol, ethanol, acetone, benzene, toluene or xylene, or a mixture of such a gas with hydrogen can be used. Furthermore, a rare gas such as a gas of helium (He) or argon (Ar) may be also introduced for stabilizing discharge and promoting plasma dissociation.

In the cold cathode field emission device according to any one of the first and second aspects of the present invention, the cold cathode field emission display according to any one of the second and third aspects of the present invention and the production method according to any one of the first to third aspects of the present invention (these will be sometimes generally referred to as “cold cathode field emission device, etc., of the present invention or the production method thereof” hereinafter), generally, the cathode electrode has an outer form of a stripe, and the gate electrode also has an outer form of a stripe. The cathode electrode in the form of a stripe extends in.one direction, and the gate electrode in the form of a stripe extends in another direction. Preferably, a projection image of the cathode electrode in the form of a stripe and a projection image of the gate electrode in the form of a stripe cross each other at right angles. In a region where these two electrodes overlap (the region corresponding to one pixel and being a region where the cathode electrode and the gate electrode overlap), one carbon film selective-growth region or a plurality of carbon film selective-growth regions are positioned. In the effective field of the cathode panel (a region which works as an actual display portion), further, such overlap regions are arranged in the form of a two-dimensional matrix.

In the cold cathode field emission device, etc., of the present invention or the production method thereof, each of the first opening portion and the second opening portion may have any plan form (form obtained by cutting these opening portions with an imaginary plane in parallel with the cathode electrode) such as the form of a circle, an oval, a rectangle, a polygon, a roundish rectangle, a roundish polygon, or the like.

In the cold cathode field emission device, etc., of the present invention or the production method thereof, the cathode electrode may have any structure such as a single layer structure of an electrically conductive material layer or a three-layered structure having a lower electrically conductive material layer, a resistance layer formed on the lower electrically conductive material layer and an upper electrically conductive material layer formed on the resistance layer. In the latter case, the carbon film selective-growth region is formed on a surface of the upper electrically conductive material layer. The above-formed resistance layer works to attain uniform electron emission properties of the electron emitting portions.

In the cold cathode field emission device, etc., of the present invention or the production method thereof, there may be employed a constitution in which a second insulating layer is further formed on the gate electrode and the insulating layer and a focus electrode is formed on the second insulating layer. Otherwise, the focus electrode may be formed above the gate electrode. The above focus electrode is provided for converging the pass of electrons which are emitted through the opening portion and attracted toward the anode electrode so that the brightness can be improved and that an optical crosstalk among neighboring pixels can be prevented. The focus electrode is effective particularly for a so-called high-voltage type display in which the anode electrode and the cathode electrode have a potential difference on the order of several kilovolts and have a relatively large distance from one to the other. A relatively negative voltage is applied to the focus electrode from a focus power source. It is not necessarily required to provide the focus electrode per cold cathode field emission device. For example, the focus electrode may be extended in a predetermined direction in which the cold cathode field emission devices are arranged, so that a common focusing effect can be exerted on a plurality of the cold cathode field emission devices.

In the method for the production of a cold cathode field emission display according to any one of the first to third aspects of the present invention, the bonding of the substrate and the supporting substrate in their circumferential portions may be carried out with an adhesive layer or with a frame made of an insulating rigid material such as glass or ceramic and an adhesive layer. When the frame and the adhesive layer are used in combination, the facing distance between the substrate and the supporting substrate can be adjusted to be longer by properly determining the height of the frame than that obtained when the adhesive layer alone is used. While a frit glass is generally used as a material for the adhesive layer, a so-called low-melting-point metal material having a melting point of approximately 120 to 400° C. may be used. The low-melting-point metal material includes In (indium; melting point 157° C.); an indium-gold low-melting-point alloy; tin (Sn)-containing high-temperature solders such as Sn₈₀Ag₂₀ (melting point 220 to 370° C.) and Sn₉₅Cug₅ (melting point 220 to 370° C.); lead (Pb)-containing high-temperature solders such as Pb_{97.5}Ag_{2.5} (melting point 304° C.), Pb_{94.5}Ag_{5.5} (melting point 304-365° C.) and Pb_{97.5}Ag_{1.5}Sn_{1.0} (melting point 309° C.); zinc (Zn)-containing high-temperature solders such as Zn₉₅Al₅ (melting point 380° C.); tin-lead-containing standard solders such as Sn₅PB₉₅ (melting point 300-314° C.) and Sn₂PB₉₈ (melting point 316-322° C.); and brazing materials such as Au₈₈Ga₁₂ (melting point 381° C.) (all of the above parenthesized values show atomic %).

When three members of the substrate, the supporting substrate and the frame are bonded, these three members may be bonded at the same time, or one of the substrate and the supporting substrate may be bonded to the frame at a first stage and then the other of the substrate and the supporting substrate may be bonded to the frame at a second stage. When bonding of the three members or bonding at the second stage is carried out in a high-vacuum atmosphere, a space surrounded by the substrate, the supporting substrate and the frame comes to be a vacuum space upon bonding. Otherwise, after the three members are bonded, the space surrounded by the substrate, the supporting substrate and the frame may be vacuumed to obtain a vacuum space. When the vacuuming is carried out after the bonding, the pressure in an atmosphere during the bonding may be any one of atmospheric pressure and reduced pressure, and the gas constituting the atmosphere may be ambient atmosphere or an inert gas containing nitrogen gas or a gas (for example, Ar gas) coming under the group O of the periodic table.

When the vacuuming is carried out after the bonding, the vacuuming can be carried out through a tip tube pre-connected to the substrate and/or the supporting substrate. Typically, the tip tube is formed of a glass tube and is bonded to a circumference of a through hole formed in an ineffective field of the substrate and/or the supporting substrate (i.e., a field other than the effective field which works as a portion) with a frit glass or the above low-melting-point metal material. After the space reaches a predetermined vacuum degree, the tip tube is sealed by thermal fusion. It is preferred to heat and then temperature-decrease the display as a whole before the sealing, since residual gas can be released into the space, and the residual gas can be removed out of the space by vacuuming.

In the cold cathode field emission device, etc., of the present invention or the production method thereof, the supporting substrate may be any substrate so long as its surface is composed of an insulating material. The supporting substrate includes a glass substrate, a glass substrate having a surface composed of an insulation layer, a quartz substrate, a quartz substrate having a surface composed of an insulation layer and a semiconductor substrate having a surface composed of an insulation layer. The substrate can have the same constitution as that of the supporting substrate. In the electron emission device of the present invention, it is required to form a conductive layer on the supporting substrate, and the supporting substrate can be composed of an insulating material.

Examples of the material constituting the conductive layer, the cathode electrode, the gate electrode or the focus electrode include metals such as tungsten (W), niobium (Nb), tantalum (Ta), molybdenum (Mo), chromium (Cr), aluminum (Al), copper (Cu), nickel (Ni), iron (Fe), titanium (Ti) and zirconium (Zr); alloys or compounds containing these metals (for example, nitrides such as TiN and silicides such as WSi₂, MoSi₂, TiSi₂ and TaSi₂); semiconductors such as silicon (Si); and ITO (indium-tin oxide). The materials for the above electrodes may be the same or different. The above electrodes can be formed by a general thin-film-forming method such as a deposition method, a sputtering method, a CVD method, an ion plating method, a screen-printing method or a plating method.

The material constituting the insulating layer or the second insulating layer includes SiO₂, SiN, SiON and a glass paste cured product, and these materials may be used alone or in combination. The insulating layer or the second insulating layer can be formed by a known method such as a CVD method, an application method, a sputtering method or a screen-printing method.

The material for the anode electrode can be selected depending upon the constitution of the cold cathode field emission display. When the cold cathode field emission display is a transmission type (the substrate corresponds to a display portion) and when the anode electrode and the fluorescent layer are stacked on the substrate in this order, not only the substrate on which the anode electrode is formed but also the anode electrode itself are required to be transparent, and a transparent electrically conductive material such as ITO (indium-tin oxide) is used. When the cold cathode field emission display is a reflection type (the supporting substrate corresponds to a display portion), or when the cold cathode field emission is a transmission type but when the fluorescent layer and the anode electrode are stacked on the substrate in this order (the anode electrode works as a metal back film as well), not only ITO can be used, but also the material can be selected from those materials which are discussed with regard to the cathode electrode, the gate electrode and the focus electrode.

The fluorescent material for the fluorescent layer can be selected from a fast-electron-excitation type fluorescent material or a slow-electron-excitation type fluorescent material. When the cold cathode field emission display is a monochrome display, it is not required to pattern the fluorescent layer. When the cold cathode field emission display is a color display, preferably, the fluorescent layers corresponding to three primary colors of red (R), green (G) and blue (B) patterned in the form of stripes or dots are alternately arranged. A black matrix may be filled in a gap between one patterned fluorescent layer and another fluorescent layer for improving a display screen in contrast.

Examples of the constitution of the anode electrode and the cathode electrode include (1) a constitution in which the anode electrode is formed on the substrate and the fluorescent layer is formed on the anode electrode and (2) a constitution in which the fluorescent layer is formed on the substrate and the anode electrode is formed on the fluorescent layer. In the above constitution (1), a so-called metal back film may be formed on the fluorescent layer. In the above constitution (2), the metal back layer may be formed on the anode electrode.

In the present invention, the electron emitting portion composed of the carbon film is formed on the carbon film selective-growth region. In this case, a kind of catalytic reaction is expected on the surface of the carbon film selective-growth region, the formation of seeds or nuclei at an initial stage of the carbon film formation proceeds smoothly, the formation of seeds or nuclei promotes the growth of the carbon film thereafter, and the electron emitting portion composed of the carbon film can be formed in a desired portion of the conductive layer or the cathode electrode. Further, it is no longer necessary to pattern the carbon film for bringing the carbon film into a desired form. When the electron emitting portion composed of the carbon film is formed in the portion of the cathode electrode which portion is positioned in the bottom portion of the opening portion and is composed of a material having a kind of function of a catalyst, it is not required to pattern the carbon film for bringing the carbon film into a desired form. Further, since the electron emitting portion is composed of the carbon film, a cold cathode field emission device having high electron emission efficiency can be obtained, so that there can be obtained a cold cathode field emission display which attains a low power consumption and a high image quality.

### BRIEF DESCRIPTION OF THE DRAWINGS

Examples of the present invention will be explained with reference to drawings hereinafter.

FIG. 1 is a schematic partial cross-sectional view of a cold cathode field emission display of Example 1.

FIG. 2 is a schematic perspective view of one electron emitting portion in the cold cathode field emission display of Example 1.

FIGS. 3A, 3B, 3C and 3D are schematic partial cross-sectional views of a supporting substrate, etc., for explaining the production method of an electron emission device in Example 1.

FIGS. 4A, 4B, 4C and 4D are schematic partial cross-sectional views of a substrate, etc., for explaining the production method of an anode panel in the cold cathode field emission display of Example 1.

FIGS. 5A and 5B are schematic partial cross-sectional views of a supporting substrate, etc., for explaining the production method of an electron emission device of Example 2.

FIG. 6 is a schematic partial end view of a cold cathode field emission display of Example 3.

FIGS. 7A and 7B are schematic partial end views of a supporting substrate, etc., for explaining the production method of a cold cathode field emission device of Example 3.

FIG. 8 is a schematic partial end view of a cold cathode field emission display of Example 6.

FIGS. 9A, 9B and 9C are schematic partial end views of a supporting substrate, etc., for explaining the production method of the cold cathode field emission device of Example 6.

FIGS. 10A and 10B, following FIG. 9C, are schematic partial end views of the supporting substrate, etc., for explaining the production method of the cold cathode field emission device of Example 6.

FIGS. 11A and 11B, following FIG. 10B, are schematic partial end views of the supporting substrate, etc., for explaining the production method of the cold cathode field emission device of Example 6.

FIGS. 12A and 12B are schematic partial end views of a supporting substrate, etc., for explaining the production method of a cold cathode field emission device of Example 10.

FIG. 13 is a schematic partial end view of a supporting substrate, etc., for explaining the production method of a cold cathode field emission device of Example 18.

FIGS. 14A and 14B are schematic partial end views of a supporting substrate, etc., for explaining the production method of a cold cathode field emission device of Example 19.

FIG. 15, following FIG. 14B, is a schematic partial end view of the supporting substrate, etc., for explaining the production method of the cold cathode field emission device of Example 19.

FIG. 16 is a schematic partial end view of a cold cathode field emission device having a focus electrode, provided by the present invention.

FIG. 17 is a schematic view of constitution example of a conventional cold cathode field emission display having a Spindt type field emission device.

### DESCRIPTION OF THE PREFERRED EMBODIMENTS

### EXAMPLE 1

Example 1 is concerned with the electron emission device of the present invention and the cold cathode field emission display (to be abbreviated as “display” hereinafter) according to the first aspect of the present invention.

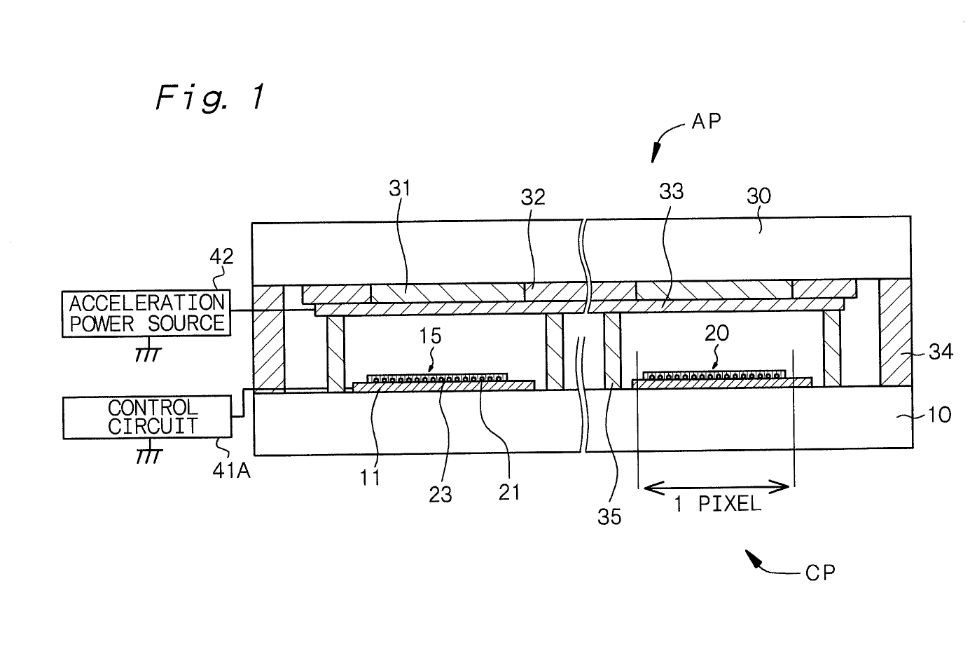

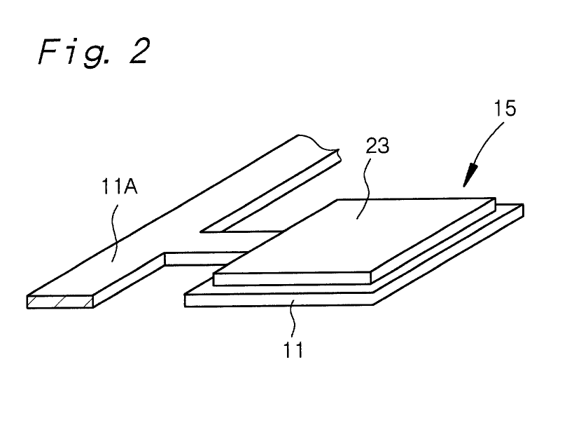

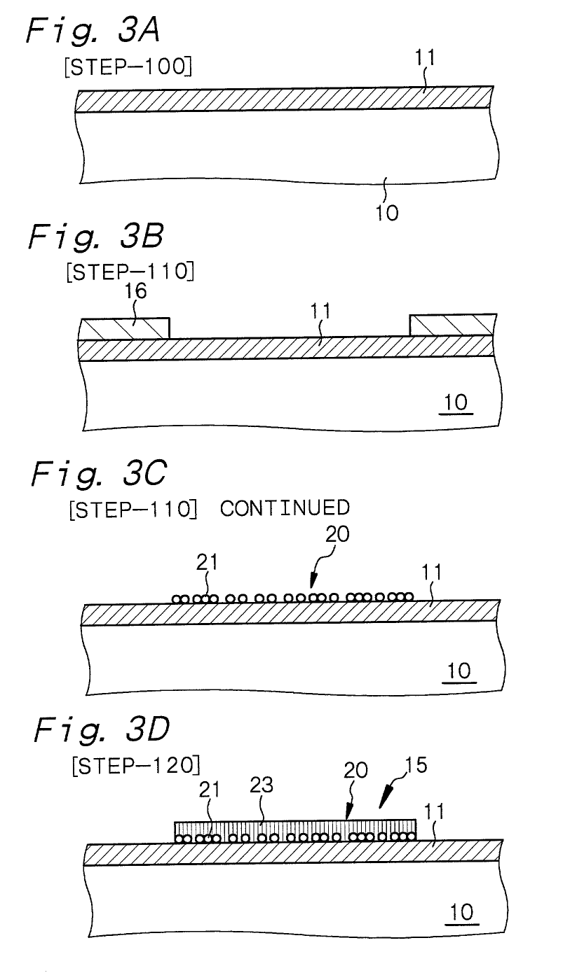

FIG. 1 shows a schematic partial cross-sectional view of the display of Example 1. FIG. 2 shows a schematic perspective view of one electron emitting portion. FIG. 3D shows a basic constitution of the electron emission device. The electron emission device of Example 1 has a conductive layer (specifically, a cathode electrode 11) having a surface on which a carbon film selective-growth region 20 is formed, and an electron emitting portion 15 composed of a carbon film 23 formed on the carbon film selective-growth region 20. The above carbon film selective-growth region 20 is formed of a portion of a conductive layer (specifically, a portion of the cathode electrode 11) which portion has a surface onto which the metal particles 21 adhere.

The display of Example 1 has a cathode panel CP having an effective field where a large number of the above electron emission devices are formed in the form of a two-dimensional matrix and an anode panel AP, and the display has a plurality of pixels. The cathode panel CP and the anode panel AP are bonded to each other through a frame 34 in their circumferential portions. Further, the cathode panel CP has a vacuuming through hole (not shown) in its ineffective field, and a tip tube (not shown) which is to be sealed after vacuuming is connected to the through hole. The frame 34 is made of ceramic or glass and has a height, for example, of 1.0 mm. In some cases, an adhesive layer alone may be used in place of the frame 34.

The anode panel AP comprises a substrate 30, a fluorescent layer 31 formed on the substrate 30 and formed in a predetermined pattern and an anode electrode 33 composed, for example, of an aluminum thin film covering the entire surface. A black matrix 32 is formed on the substrate 30 between one fluorescent layer 31 and another fluorescent layer 31. The black matrix 32 may be omitted. When it is intended to produce a monochrome display, the fluorescent layer 31 is not required to be in a predetermined pattern. Further, an anode electrode composed of a transparent electrically conductive film of ITO or the like may be formed between the substrate 30 and the fluorescent layer 31. Otherwise, the anode panel AP may be constituted of the anode electrode 33 composed of a transparent electrically conductive film provided on the substrate 30, the fluorescent layer 31 and the black matrix 32 both formed on the anode electrode 32, and a light reflection electrically conductive film which is composed of aluminum, is formed on the fluorescent layer 31 and the black matrix 32 and is electrically connected to the anode electrode 33.

Each pixel is constituted of the cathode electrode 11 having a rectangular form on the cathode panel side, the electron emitting portion 15 formed thereon and the fluorescent layer 31 arranged in the effective field of the anode panel AP so as to face the electron emission device. In the effective field, such pixels are arranged on the order, for example, of hundreds of thousands to several millions.

Further, spacers 35 as auxiliary means are disposed between the cathode panel CP and the anode panel AP for maintaining a constant distance between these two panels, and the spacers 35 are disposed in regular intervals in the effective field. The form of the spacers 35 is not limited to a columnar form, and the spacers 35 may have a spherical form or may be ribs in the form of a stripe. It is not required to arrange the spacers 35 in four corners of each overlap region of the anode electrode and the cathode electrode. The spacers 35 may be more sparsely arranged, or the arrangement thereof may be irregular.

In the above display, the voltage to be applied to the cathode electrode 11 is controlled in the unit of one pixel. When viewed as a plan view, the cathode electrode 11 has a nearly rectangular form as is schematically shown in FIG. 2, and each cathode electrode 11 is connected to a control circuit 41A through a wiring 11A and a switching element (not shown) formed, for example, of a transistor. Further, the anode electrode 33 is connected to an accelerating power source 42. When a voltage higher than a threshold voltage is applied to each cathode electrode 11, electrons are emitted from the electron emitting portion 15 on the basis of a quantum tunnel effect due to an electric field generated by the anode electrode 33, and the electrons are attracted toward the anode electrode 33 and collide with the fluorescent layer 31. The brightness is controlled on the basis of a voltage applied to the cathode electrode 11.

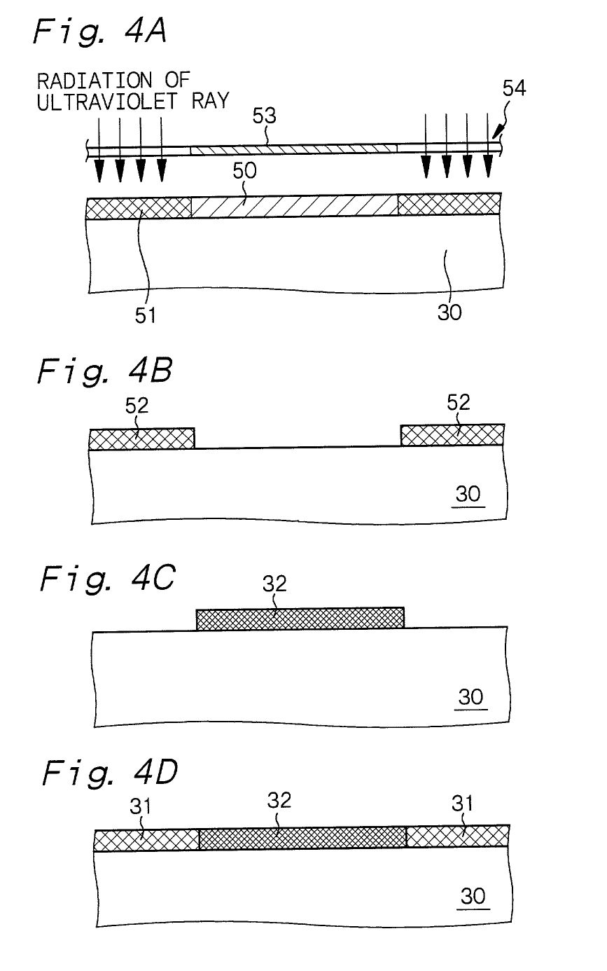

The method for the production of the electron emission device and the display in Example 1 will be explained with reference to FIGS. 3A to 3D and FIGS. 4A to 4D. In Example 1, nickel (Ni) is used as a material for the carbon film selective-growth region 20.

[Step-100]

First, an electrically conductive material layer for a cathode electrode is formed on the supporting substrate 10 made, for example, of a glass substrate. Then, the electrically conductive material layer is patterned by known lithography and a reactive ion etching method (RIE method), to form the rectangular cathode electrode 11 on the supporting substrate 10 (see FIG. 3A). At the same time, a wiring 11A (see FIG. 2) connected to the cathode electrode 11 is formed on the supporting substrate 10. The electrically conductive material layer is composed, for example, of an approximately 0.2 μm thick chromium layer formed by a sputtering method. Table 3 shows a condition of forming the chromium layer by a sputtering method, and Table 2 shows a condition of etching the chromium layer.

TABLE 1
(Condition of forming chromium layer)

| | |
|---|---|
| Target | Cr |
| Ar flow rate | 100 SCCM |
| Pressure | 5 Pa |
| DC power | 2 kW |
| Sputtering temperature | 200° C. |

TABLE 2
(Condition of etching chromium layer)

| | |
|---|---|
| Etching apparatus | Parallel plate reactive ion |
| | etching system |
| Cl₂ flow rate | 100 SCCM |
| Pressure | 0.7 Pa |
| RF power | 0.8 kW (13.56 MHz) |
| Etching temperature | 60° C. |

[Step-110]

Then, the carbon film selective-growth region 20 is formed on the surface of the cathode electrode 11. Specifically, a resist material layer is first formed on the entire surface by a spin coating method, and then a mask layer 16 composed of the resist material layer is formed by lithography so as to expose a surface of a portion of the cathode electrode 11 in which portion the carbon film selective-growth region 20 is to be formed, that is, a surface of the cathode electrode portion (see FIG. 3B). Then, metal particles are allowed to adhere onto the mask layer 16 and the exposed surface of the cathode electrode 11. Specifically, a dispersion prepared by dispersing nickel (Ni) fine particles in a polysiloxane solution (using isopropyl alcohol as a solvent) is applied to the entire surface by a spin coating method, to form a layer composed of the solvent and the metal particles on the surface of the cathode electrode portion. Then, the mask layer 16 is removed, and the solvent is removed by heating the above layer up to approximately 400° C., to retain the metal particles 21 on the exposed surface of the cathode electrode 11, whereby the carbon film selective-growth region 20 can be obtained (see FIG. 3C). The above polysiloxane works to fix the metal particles 21 to the exposed surface of the cathode electrode 11 (so-called adhesive function).

[Step-120]

Then, the carbon film 23 having a thickness of approximately 0.2 μm is formed on the carbon film selective-growth region 20, to obtain the electron emitting portion 15. FIG. 3D shows the thus-obtained state. Table 3 shows a condition of forming the carbon film 23 by a microwave plasma CVD method. Under a conventional carbon film formation condition, a film forming temperature of approximately 900° C. has been required. In Example 1, however, the carbon film is stably formed at a film forming temperature of 500° C.

TABLE 3
(Condition of forming carbon film)

| | |
|---|---|
| Gas used | CH₄/H₂ = 100/10 SCCM |
| Pressure | 1.3 × 10³ Pa |
| Microwave power | 500 W (13.56 Mz) |
| Film forming temperature | 500° C. |

[Step-130]

Then, a display is assembled. Specifically, the anode panel AP and the cathode panel CP are arranged such that the fluorescent layer 31 and the electron emission device (or field emission device) face each other, and the anode panel AP and the cathode panel CP (more specifically, the substrate 30 and the supporting substrate 10) are bonded to each other in their circumferential portions through the frame 34. In the above bonding, a frit glass is applied to bonding portions of the frame 34 and the anode panel AP and bonding portions of the frame 34 and the cathode panel CP. Then, the anode panel AP, the cathode panel CP and the frame 34 are attached. The frit glass is pre-calcined or pre-sintered to be dried, and then fully calcined or sintered at approximately 450° C. for 10 to 30 minutes. Then, a space surrounded by the anode panel AP, the cathode panel CP, the frame 34 and the frit glass is vacuumed through a through hole (not shown) and a tip tube (not shown), and when the space comes to have a pressure of approximately 10⁻⁴ Pa, the tip tube is sealed by thermal fusion. In the above manner, the space surrounded by the anode panel AP, the cathode panel CP and the frame 34 can be vacuumed. Then, wiring to external circuits is carried out to complete the display.

One example of method of preparing the anode panel AP in the display shown in FIG. 1 will be explained with reference to FIGS. 4A to 4D. First, a light-emitting crystal particle composition is prepared. For this purpose, for example, a dispersing agent is dispersed in pure water, and the mixture is stirred with a homo-mixer at 3000 rpm for 1 minute. Then, the light-emitting crystal particles are poured into the dispersion of the dispersing agent and pure water, and the mixture is stirred with a homo-mixer at 5000 rpm for 5 minutes. Then, for example, polyvinyl alcohol and ammonium bichromate are added, and the resultant mixture is fully stirred and filtered.

In the preparation of the anode panel AP, a photosensitive coating 50 is formed (applied) on the entire surface of a substrate 30 made, for example, of glass. Then, the photosensitive coating 50 formed on the substrate 30 is exposed to ultraviolet ray which is radiated from a light source (not shown) and passes through openings 54 formed in a mask 53, to form a light-exposed region 51 (see FIG. 4A). Then, the photosensitive coating 50 is selectively removed by development, to retain a remaining photosensitive coating portion (exposed and developed photosensitive coating) 52 on the substrate 30 (see FIG. 4B). Then, a carbon agent (carbon slurry) is applied to the entire surface, dried and calcined or sintered, and then, the remaining photosensitive coating portion 52 and the carbon agent thereon are removed by a lift-off method, whereby a black matrix 32 composed of the carbon agent is formed on the exposed substrate 30, and at the same time, the remaining photosensitive coating portion 52 is removed (see FIG. 4C). Then, fluorescent layers 31 of red, green and blue are formed on the exposed substrate 30 (see FIG. 4D). Specifically, the light-emitting crystal particle compositions prepared from the light-emitting crystal particles (fluorescent particles) are used. For example, a red photosensitive light-emitting crystal particle composition (fluorescent slurry) is applied to the entire surface, followed by exposure to ultraviolet ray and development. Then, a green photosensitive light-emitting crystal particle composition (fluorescent slurry) is applied to the entire surface, followed by exposure to ultraviolet ray and development. Further, a blue photosensitive light-emitting crystal particle composition (fluorescent slurry) is applied to the entire surface, followed by exposure to ultraviolet ray and development. Then, the anode electrode 33 composed of an approximately 0.07 μm thick aluminum thin film is formed on the fluorescent layers 31 and the black matrix 32 by a sputtering method. Alternatively, each fluorescent layer 31 can be also formed by a screen-printing method or the like.

In the display having the above constitution, the electron emitting portion of each electron emission device is composed of the flat carbon film 23 having a low work function, and the fabrication thereof does not require such complicated and advanced fabrication techniques as have been required concerning the conventional Spindt type field emission device. Moreover, the etching of the carbon film 23 is no longer required. When the area of the effective field of a display increases and when the number of electron emitting portions to be formed increases accordingly to a great extent, the electron emission efficiency of the electron emitting portions can be rendered uniform throughout the entire region of the effective field, and there can be realized a display which is remarkably free of non-uniformity in brightness and has high image quality.

### EXAMPLE 2

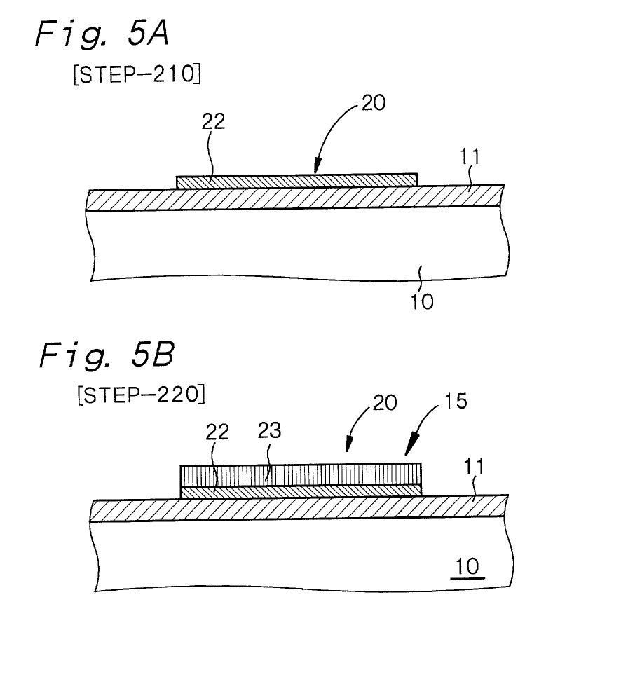

Example 2 is directed to variants of the electron emission device and the display explained in Example 1. In the production method explained in Example 1, the metal particles 21 are allowed to adhere onto the surface of the cathode electrode portion. In Example 2, the step of forming a carbon film selective-growth region comprises the step of forming a metal thin layer composed of titanium (Ti) by a sputtering method. The method for the productions of the electron emission device and the display in Example 2 will be explained below with reference to FIGS. 5A and 5B.

[Step-200]

A cathode electrode 11 is formed on a supporting substrate 10 made, for example, of glass in the same manner as in [Step-100] in Example 1. Then, a resist material layer is formed on the entire surface by a spin coating method, and then, a mask layer composed of the resist material layer is formed by lithography so as to expose a surface of the cathode electrode portion.

[Step-210]

Then, a metal thin layer 22 is formed on the mask layer and the exposed surface of the cathode electrode 11 by a sputtering method under a condition shown in Table 4, and then the mask layer is removed (see FIG. 5A). In the above manner, there can be obtained the carbon film selective-growth region 20 composed of the metal thin layer 22 formed on the surface of the cathode electrode portion.

TABLE 4
(Condition of forming metal thin layer)

| | |
|---|---|
| Target | Ti |
| Process gas | Ar = 100 SCCM |
| DC power | 4 kW |
| Pressure | 0.4 Pa |
| Substrate heating | 150° C. |
| temperature | |
| Layer thickness | 30 nm |

Then, a carbon film 23 having a thickness of approximately 0.2 μm is formed on the carbon film selective-growth region 20 in the same manner as in [Step-120] in Example 1, to obtain an electron emitting portion (see FIG. 5B). Then, a display is assembled in the same manner as in [Step-130] in Example 1.

### EXAMPLE 3

Example 3 is directed to the cold cathode field emission device (to be abbreviated as “field emission device” hereinafter) according to the first aspect of the present invention and the display according to the second aspect of the present invention.

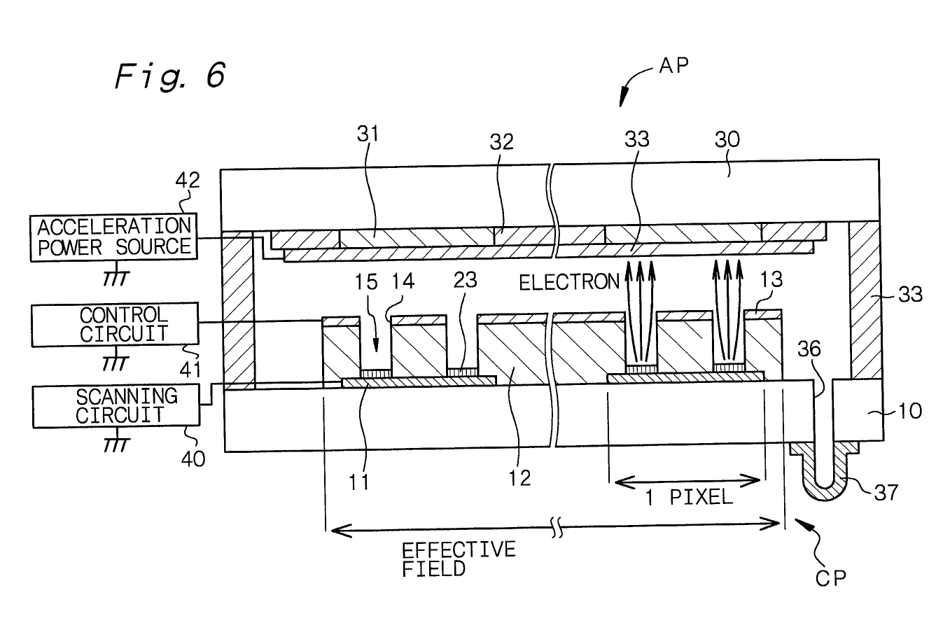

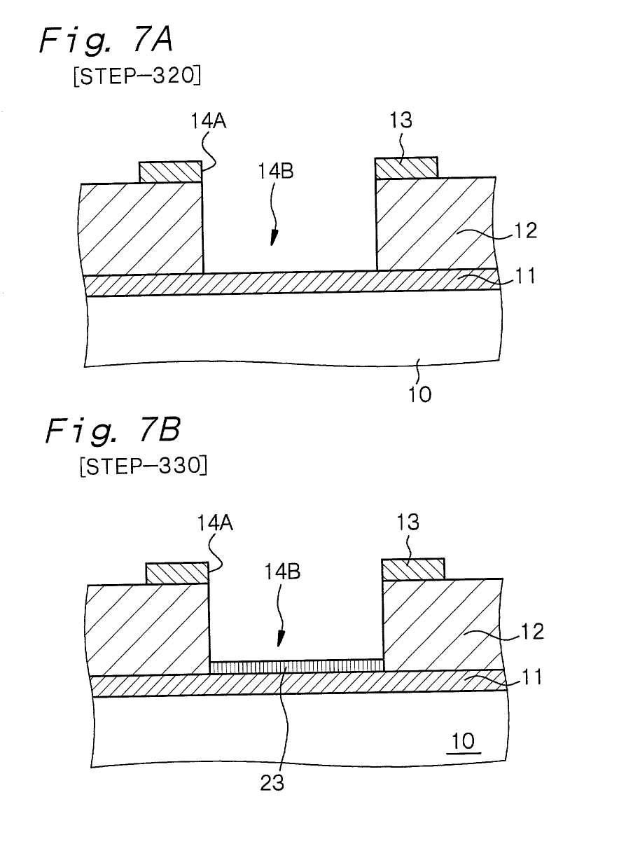

FIG. 6 shows a schematic partial end view of the display, of Example 3. FIG. 7B shows a basic constitution of the field emission device. The field emission device of Example 3 has a cathode electrode 11 formed on a supporting substrate 10 and a gate electrode 13 which is formed above the cathode electrode 11 and has an opening portion (first opening portion 14A). The field emission device further has an electron emitting portion 15 composed of a carbon film 23 formed on a surface of a portion of a cathode electrode 11 which portion is positioned in a bottom portion of the opening portion 14A. An insulating layer 12 is formed on the supporting substrate 10 and the cathode electrode 11, and an opening portion 14B communicating with the first opening portion 14A formed in the gate electrode 13 is formed in the insulating layer 12. In Example 3, the cathode electrode 11 is composed of copper (Cu).

The display of Example 3 is also constituted of a cathode panel CP having a number of the above field emission devices formed in an effective field in the form of a two-dimensional matrix and an anode panel AP, and the display has a plurality of pixels. The cathode panel CP and the anode panel AP are bonded to each other in their circumferential portions through a frame 34. Further, a through hole 36 for vacuuming is formed in an ineffective field of the cathode panel CP, and a tip tube 37 which is to be sealed after vacuuming is connected to the through hole 36. The frame 34 is made of ceramic and has a height, for example, of 1.0 mm. In some cases, an adhesive layer alone may be used in place of the frame 34.

The anode panel AP can have the same structure as that explained in Example 1, so that a detailed explanation thereof is omitted.

Each pixel is constituted of the cathode electrode 11 having the form of a stripe on the cathode panel side, the electron emitting portion 15 formed thereon and a fluorescent layer 31 arranged in the effective field of the anode panel AP so as to face the field emission device. In the effective field, such pixels are arranged on the order of hundreds of thousands to several millions.

A relatively negative voltage is applied to the cathode panel 11 from a scanning circuit 40, a relatively positive voltage is applied to the gate electrode 13 from a control circuit 41, and a higher positive voltage than the voltage to the gate electrode 13 is applied to the anode electrode 33 from an accelerating power source 42. When such a display is used for displaying, for example, a scanning signal is inputted to the cathode electrode 11 from the scanning circuit 40, and a video signal is inputted to the gate electrode 13 from the control circuit 41. Electrons are emitted from the electron emitting portion 15 on the basis of a quantum tunnel effect due to an electric filed generated when a voltage is applied between the cathode electrode 11 and the gate electrode 13, and the electrons are attracted toward the anode electrode 33 and collide with the fluorescent layer 31. As a result, the fluorescent layer 31 is excited to emit light, and a desired image can be obtained.

The method for the production of the field emission device and the display of Example 3 will be explained below with reference to FIGS. 7A and 7B.

[Step-300]

First, an electrically conductive material layer for a cathode electrode is formed on the supporting substrate 10 made, for example, of a glass substrate. Then, the electrically conductive material layer is patterned by known lithography and a known RIE method, to form the cathode electrode 11 having the form of a stripe on the supporting substrate 10. The cathode electrode 11 in the form of a stripe extends leftward and rightward on the paper surface of the drawing. The electrically conductive material layer is composed, for example, of an approximately 0.2 μm thick copper (Cu) layer formed by a sputtering method.

[Step-310]

Then, the insulating layer 12 is formed on the supporting substrate 10 and the cathode electrode 11. Specifically, the insulating layer 12 having a thickness of approximately 1 μm is formed on the entire surface, for example, by a CVD method using TEOS (tetraethoxysilane) as a source gas. Table 5 shows one example of a condition of forming the insulating layer 12.

TABLE 5
(Condition of forming insulating layer)

| | |
|---|---|
| TEOS flow rate | 800 SCCM |
| O₂ flow rate | 600 SCCM |
| Pressure | 1.1 kPa |
| RF power | 0.7 kW (13.56 MHz) |
| Film forming temperature | 400° C. |

[Step-320]

Then, the gate electrode 13 having the first opening portion 14A is formed on the insulating layer 12. Specifically, an electrically conductive material layer composed of chromium (Cr) for a gate electrode is formed on the insulating layer 12 by a sputtering method, and then a first mask material layer (not shown) patterned is formed on the electrically conductive material layer. The electrically conductive material layer is etched with using the first mask material layer as an etching mask to pattern the electrically conductive material layer in the form of a stripe, and then the first mask material layer is removed. Then, a second mask material layer (not shown) patterned is formed on the electrically conductive material layer and the insulating layer 12, and the electrically conductive material layer is etched with using the second mask material layer as an etching mask. In this manner, the gate electrode 13 having the first opening portion 14A can be formed on the insulating layer 12. The gate electrode 13 in the form of a stripe extends in a direction (for example, direction perpendicular to the paper surface of the drawing) different from the direction of the cathode electrode 11. Thereafter, the second opening portion 14B communicating with the first opening portion 14A formed in the gate electrode 13 is formed in the insulating layer 12. Specifically, the insulating layer 12 is etched by an RIE method using the second mask material layer as an etching mask, and then the second mask material layer is removed. In this manner, a structure shown in FIG. 7A can be obtained. Table 6 shows a condition of etching the insulating layer 12. In Example 3, the first opening portion 14A and the second opening portion 14B has a one-to-one correspondence relationship. That is, one second opening portion 14B is formed per first opening portion 14A. When viewed as a plan view, the first and the second opening portions 14A and 14B have the form of a circle having a diameter of 1 to 30 μm. It is sufficient to form the opening portions 14A and 14B in the quantity of approximately 1 to 3000 per pixel.

TABLE 6
(Condition of etching insulating layer)

| | |
|---|---|
| Etching apparatus | Parallel plate reactive ion |
| | etching system |
| C₄F₈ flow rate | 30 SCCM |
| CO flow rate | 70 SCCM |
| Ar flow rate | 300 SCCM |
| Pressure | 7.3 Pa |
| RF power | 1.3 kW (13.56 MHz) |
| Etching temperature | room temperature |

[Step-330]

Then, the electron emitting portion 15 composed of the carbon film 23 is formed on the surface of a portion of the cathode electrode 11 which portion is positioned in a bottom portion of the opening portions 14A and 14B. The cathode electrode 11 is composed of a copper (Cu) which works as a kind of a catalyst. Specifically, the carbon film 23 having a thickness of approximately 0.2 μm is formed on the surface of the portion of the cathode electrode 11 to obtain the electron emitting portion 15. FIG. 7B shows the thus-obtained state. Table 7 shows a condition of forming the carbon film 23 according to a microwave plasma CVD method. Under a conventional carbon film formation condition, a film forming temperature of approximately 900° C. has been required. In Example 3, however, the carbon film is stably formed at a film forming temperature of 300° C. Since the gate electrode 13 is formed of chromium (Cr), no carbon film is formed on the gate electrode 13.

TABLE 7
(Condition of forming carbon film)

| | |
|---|---|
| Gas used | CH₄/H₂ = 100/10 SCCM |
| Pressure | 1.3 × 10³ Pa |
| Microwave power | 500 W (13.56 Mz) |
| Film forming temperature | 300° C. |

[Step-340]

A display is assembled in the same manner as in [Step-130] in Example 1.

In Example 3, the carbon film 23 is formed on the surface of the portion of the cathode electrode 11 which portion is positioned in the bottom portion of the opening portions 14A and 14B and the cathode electrode 11 is composed of a material which works as a kind of a catalyst, so that it is no longer necessary to pattern the carbon film 23 to bring it into a desired form.

### EXAMPLE 4

Example 4 is a variant of Example 3. In the production method for each of the field emission device and the display explained in Example 3, the surface of the cathode electrode 11 is naturally oxidized, so that it is sometimes difficult to form the carbon film 23. In Example 4, the metal oxide (so-called natural oxide film) is removed from the surface of the cathode electrode portion. The metal oxide on the surface of the cathode electrode portion can be removed by plasma reduction treatment or washing.

The field emission device and the display to be produced in Example 4 or Example 5 to be described later are structurally the same as those in Example 3, so that detailed explanations thereof are omitted. The method for the production of the field emission device and the display in Example 4 will be explained below.

[Step-400]

First, in the same manner as in [Step-300] to [Step-320] in Example 3, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-410]

Then, the metal oxide (natural oxide film) on the surface of the portion of the cathode electrode 11 which portion is exposed in the bottom portion of the opening portions 14A and 14B is removed by plasma reduction treatment (microwave plasma treatment) under a condition shown in Table 8. otherwise, the metal oxide (natural oxide film) on the exposed surface of the cathode electrode portion can be removed, for example, with a 50% hydrofluoric acid aqueous solution/pure water mixture having a 50% hydrofluoric acid aqueous solution:pure water mixing ratio of 1:49 (volume ratio).

TABLE 8

| | |
|---|---|
| Gas used | H₂ = 100 SCCM |
| Pressure | 1.3 × 10³ Pa |
| Microwave power | 600 W (13.56 MHz) |
| Treating temperature | 400° C. |

[Step-420]

Then, the carbon film 23 having a thickness of approximately 0.2 μm is formed on the surface of the portion of the cathode electrode 11 which portion is exposed in the bottom portion of the opening portions 14A and 14B, to obtain the electron emitting portion 15. Table 9 shows a condition of forming the carbon film 23 according to a microwave plasma CVD method. In Example 4, the carbon film is stably formed at a film-forming temperature of 200° C.

TABLE 9
(Condition of forming carbon film)

| | |
|---|---|
| Gas used | CH₄/H₂ = 100/10 SCCM |
| Pressure | 1.3 × 10³ Pa |
| Microwave power | 500 W (13.56 Mz) |
| Film forming temperature | 200° C. |

[Step-430]

Then, the display is assembled in the same manner as in [Step-130] in Example 1.

In Example 4, the metal oxide (natural oxide film) on the surface of the portion of the cathode electrode 11 which portion is exposed in the bottom portion of the opening portions 14A and 14B is removed, and then the carbon film is formed on the surface of the cathode electrode portion, so that the carbon film can be formed at a far lower temperature.

### EXAMPLE 5

Example 5 is also a variant of Example 3. In Example 5, a convexo-concave shape is formed in the surface of the portion of the cathode electrode 11 which portion is exposed in the bottom portion of the opening portions 14A and 14B. Protrusions are therefore formed in the carbon film formed thereon. As a result, a field emission device having high electron emission efficiency can be obtained. The method for the production of the field emission device and the display in Example 5 will be explained below.

[Step-500]

First, in the same manner as in [Step-300] to [Step-320] in Example 3, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-510]

Then, the surface of the portion of the cathode electrode 11 which portion is positioned in the bottom portion of the opening portions 14A and 14B is etched to form a convexo-concave shape. Table 10 shows a condition of the above etching.

TABLE 10

| | |
|---|---|
| Etching solution | 1% hydrochloric acid |
| | aqueous solution |
| Treatment time | 5 minutes |
| period | |

[Step-520]

Then, a step similar to [Step-330] in Example 3 is carried out to form an electron emitting portion 15 composed of a carbon film 23 on the surface of the portion of the cathode electrode 11 which portion is positioned in the bottom portion of the opening portions 14A and 14B. Specifically, the carbon film 23 having a thickness of approximately 0.2 μm is formed on the above surface of the portion of the cathode electrode 11 to obtain the electron emitting portion 15. Table 11 shows a condition of forming the carbon film 23 according to a microwave plasma CVD method. Under a conventional carbon film formation condition, a film forming temperature of approximately 900° C. has been required. In Example 5, however, the carbon film is stably formed at a film-forming temperature of 200° C.

TABLE 11
(Condition of forming carbon film)

| | |
|---|---|
| Gas used | CH₄/H₂ = 100/10 SCCM |
| Pressure | 7 × 10² Pa |
| Microwave power | 700 W (13.56 Mz) |
| Film forming | 200° C. |
| temperature | |

[Step-530]

Then, the display is assembled in the same manner as in [Step-130] in Example 1.

The step of forming the convexo-concave shape on the surface of the portion of the cathode electrode 11 which portion is exposed in the bottom portion of the opening portions 14A and 14B, explained in Example 5, can be applied to Example 4. Further, the removal of the metal oxide (natural oxide film) explained in Example 4 can be applied to Example 5.

### EXAMPLE 6

Example 6 is directed to the electron emission device of the present invention, the field emission device according to the second aspect of the present invention, the display according to the third aspect of the present invention and the production method according to the first aspect of the present invention.

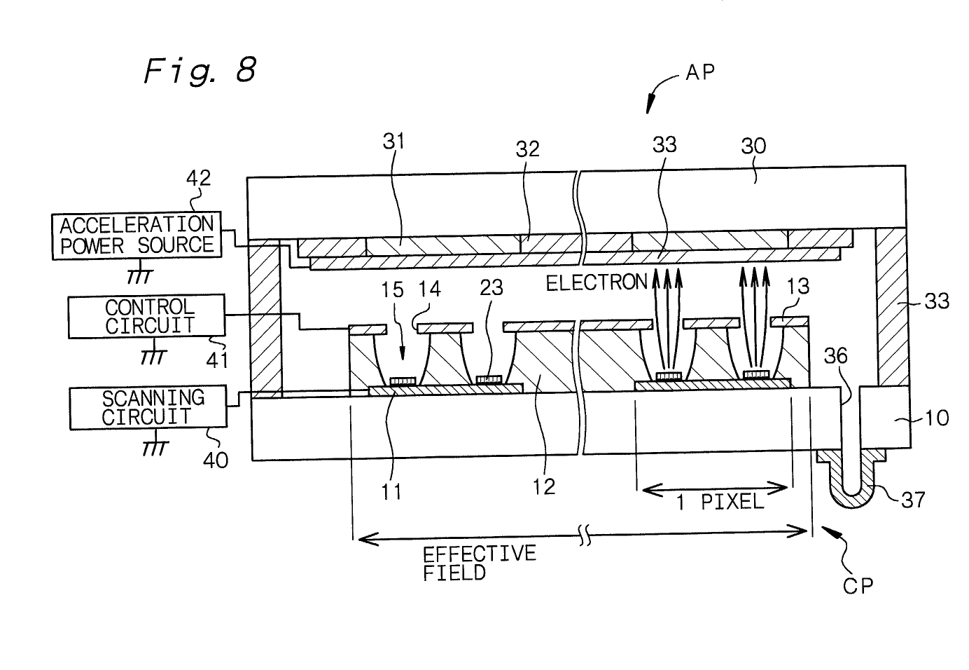

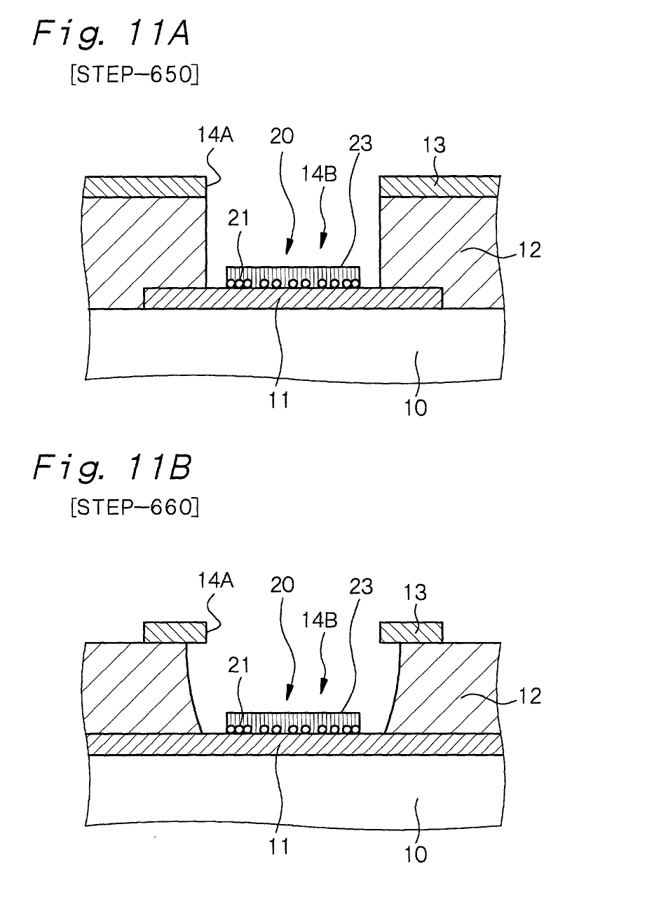

FIG. 11B shows a schematic partial end view of the field emission device of Example 6. FIG. 8 shows a schematic partial end view of the display of Example 6. The field emission device has a cathode electrode 11 formed on a supporting substrate 10 and a gate electrode 13 which is formed above the cathode electrode 11 and has a first opening portion 14A. The field emission device further has a carbon film selective-growth region 20 formed on a surface of a portion of the cathode electrode 11 which portion is positioned in a bottom portion of the opening portions 14A and 14B, and an electron emitting portion composed of a carbon film 23 formed on the carbon film selective-growth region 20. In Example 6, the carbon film selective-growth region 20 is a portion of the cathode electrode 11 which portion has a surface onto which metal particles 21 composed of nickel (Ni) adhere.

In the field emission device of Example 6, an insulating layer 12 is formed on the supporting substrate 10 and the cathode electrode 11, the second opening portion 14B communicating with the first opening portion 14A formed in the gate electrode 13 is formed in the insulating layer 12, and the carbon film 23 is positioned in the bottom portion of the second opening portion 14B.

FIG. 8 shows a constitution example of the display of Example 6. The display is constituted of a cathode panel CP having a large number of the above-explained field emission devices formed in an effective region, an anode panel AP and has a plurality of pixels. Each pixel is constituted of the field emission device, an anode electrode 33 and a fluorescent layer 31 formed on a substrate 30 so as to be opposed to the field emission device. The cathode panel CP and the anode panel AP are bonded in their circumferential portions through a frame 34. In the end view of FIG. 8, two opening portions (14A and 14B) and two carbon films 23 which are electron emitting portions are shown per cathode electrode 11 on the cathode panel CP, for simplifying the drawing. However, the number of each of these members shall not be limited thereto. The basic constitution of the field emission device is as shown in FIG. 11B. Further, a through hole 36 for vacuuming is provided in an ineffective field of the cathode panel CP, and a tip tube which is sealed after vacuuming is connected to the through hole 36. FIG. 8 shows a completed state of the display, and the shown tip tube 37 is already sealed.

The anode panel AP can have the same structure as that explained in Example 1, so that a detailed explanation thereof is omitted.

The operation of the display for displaying can be the same as the operation of the display explained in Example 3, so that a detailed explanation thereof is omitted.

The method for the production of the field emission device and the method for the production of the display in Example 6 will be explained below with reference to FIGS. 8, 9A, 9B, 9C, 10A, 10B, 11A and 11B.

[Step-600]

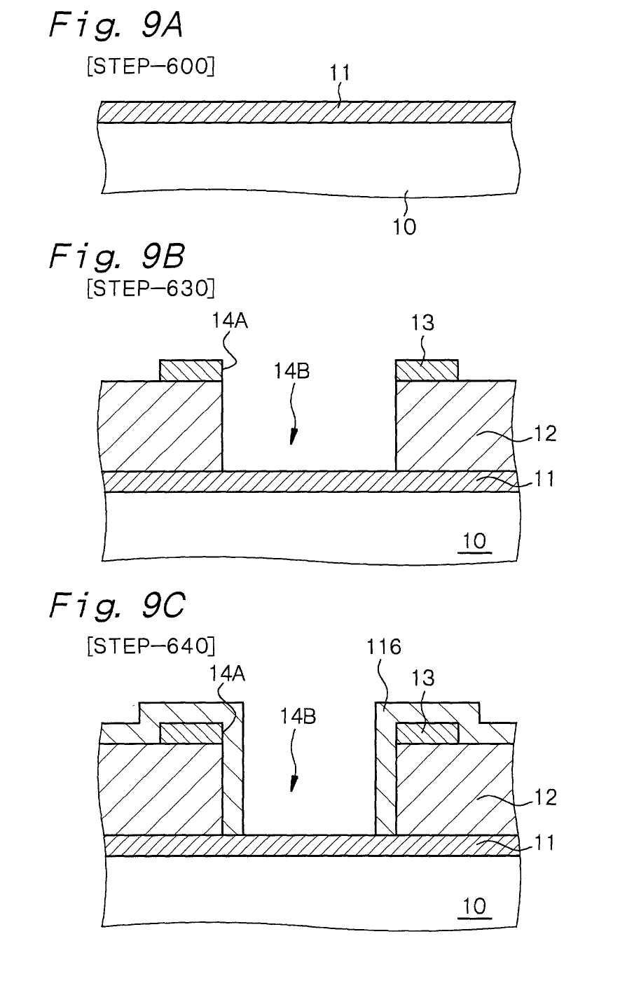

First, an electrically conductive material layer for a cathode electrode is formed on the supporting substrate 10 made, for example, of glass, and the electrically conductive material layer is then patterned by known lithography and a known RIE method, to form the cathode electrode 11 in the form of a stripe on the supporting substrate 10 (see FIG. 9A). The cathode electrode 11 in the form of a stripe extends leftward and rightward on the paper surface of the drawing. The electrically conductive material layer is composed, for example, of an approximately 0.2 μm thick chromium (Cr) layer formed by a sputtering method. The condition of forming the chromium layer by a sputtering method and the condition of etching it are as shown in Tables 1 and 2.

[Step-610]

Then, an insulating layer 12 is formed on the supporting substrate 10 and the cathode electrode 11. Specifically, the insulating layer 12 having a thickness of approximately 1 μm is formed on the entire surface, for example, by a CVD method using TEOS (tetraethoxysilane) as a source gas. The insulating layer 12 can be formed under the condition shown in Table 5.

[Step-620]

Then, the gate electrode 13 having the first opening portion 14A is formed on the insulating layer 12. Specifically, an electrically conductive material layer composed of chromium (Cr) for a gate electrode is formed on the insulating layer 12 by a sputtering method under the condition shown in Table 1, and then a patterned first mask material layer (not shown) is formed on the electrically conductive material layer. The electrically conductive material layer is then etched under the condition shown in Table 2 with using the above first mask material layer as an etching mask and patterned in the form of a stripe, and then the first mask material layer is removed. Then, a patterned second mask material layer (not shown) is formed on the electrically conductive material layer and the insulating layer 12, and the electrically conductive material layer is etched with using the above second mask material layer as an etching mask under the condition shown in Table 2. In this manner, the gate electrode 13 having the first opening portion 14A can be formed on the insulating layer 12. The gate electrode 13 in the form of a stripe extends in a direction (direction perpendicular to the paper surface of the drawing) different from the direction in which the cathode electrode 11 extends.

[Step-630]

Then, the second opening portion 14B communicating with the first opening portion 14A formed in the gate electrode 13 is formed in the insulating layer 12. Specifically, the insulating layer 12 is etched by an RIE method with using the second mask material layer as an etching mask, and then the second mask material layer is removed. In this manner, a structure shown in FIG. 9B can be obtained. The insulating layer 12 can be etched under the condition shown in Table 6. In Example 6, the first opening portion 14A and the second opening portion 14B have a one-to-one correspondence relationship. That is, one second opening portion 14B is formed per first opening portion 14A. When viewed as a plan view, the first and second opening portions 14A and 14B have the form, for example, of a circle having a diameter of 1 to 30 μm. It is sufficient to form 1 to approximately 3000 opening portions 14A and 14B per pixel.

[Step-640]

Then, the carbon film selective-growth region 20 is formed on the surface of the portion of the cathode electrode 11 which portion is positioned in the bottom portion of the second opening portion 14B. For this purpose, first, a mask layer 116 is formed so as to expose the surface of the cathode electrode 11 in a central portion of the bottom portion of the second opening portion 14B (see FIG. 9C). Specifically, a resist material layer is formed on the entire surface including the inner surfaces of the opening portions 14A and 14B by a spin coating method, and then a hole is formed in the resist material layer positioned in the central portion of the bottom portion of the second opening portion 14B by lithography, whereby the mask layer 116 can be obtained. In Example 6, the mask layer 116 covers part of the cathode electrode 11 which part is positioned in the bottom portion of the second opening portion 14B, a side wall of the second opening portion 14B, a side wall of the first opening portion 14A, the gate electrode 13 and the insulating layer 12. While the carbon film selective-growth region is to be formed on the surface of the portion of the cathode electrode 11 which portion is positioned in the central portion of the bottom portion of the second opening portion 14B in a step to come thereafter, the above mask layer can reliably prevent short-circuiting between the cathode electrode 11 and the gate electrode 13 with metal particles.

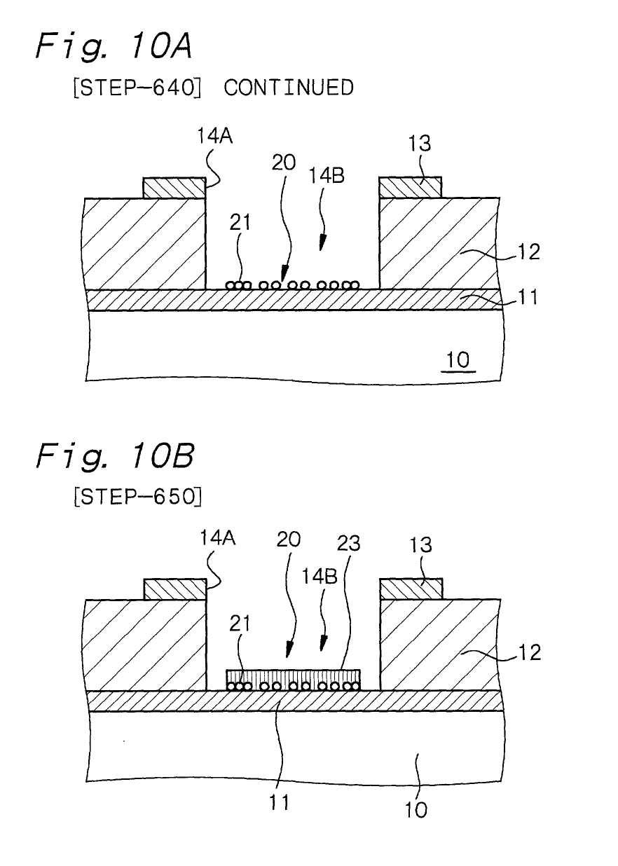

Then, metal particles are allowed to adhere onto the mask layer 116 and the exposed surface of the cathode electrode 11. Specifically, a dispersion prepared by dispersing nickel (Ni) fine particles in a polysiloxane solution (using isopropyl alcohol as a solvent) is applied to the entire surface by a spin coating method, to form a layer composed of the solvent and the metal particles on the surface of the cathode electrode portion. Then, the mask layer 116 is removed, and the solvent is removed by heating the above layer up to approximately 400° C., to retain the metal particles 21 on the exposed surface of the cathode electrode 11, whereby the carbon film selective-growth region 20 can be obtained (see FIG. 10A). The above polysiloxane works to fix the metal particles 21 to the exposed surface of the cathode electrode 11 (so-called adhesive function).

[Step-650]

Then, the carbon film 23 having a thickness of approximately 0.2 μm is formed on the carbon film selective-growth region 20, to obtain an electron emitting portion. FIGS. 10B and 11A show the thus-obtained state. FIG. 10B is a schematic partial end view obtained when the device is viewed from a direction in which the gate electrode 13 extends. FIG. 11A is a schematic partial end view obtained when the device is viewed from a direction in which the cathode electrode 11 extends. Table 12 shows a condition of forming the carbon film 23 by a microwave plasma CVD method. Under a conventional carbon film formation condition, a film forming temperature of approximately 900° C. has been required. In Example 6, however, the carbon film is stably formed at a film forming temperature of 500° C.

TABLE 12
(Condition of forming carbon film)

| | |
|---|---|
| Gas used | CH₄/H₂ = 100/10 SCCM |
| Pressure | 1.3 × 10³ Pa |
| Microwave power | 500 W (13.56 Mz) |
| Film forming temperature | 500° C. |

[Step-660]

For exposing the opening end portion of the gate electrode 13, preferably, the side wall surface of the second opening portion 14B formed in the insulating layer 12 is allowed to recede by isotropic etching. In this manner, the field emission device shown in FIG. 11B can be completed. Otherwise, there can be obtained an electron emission device which comprises the conductive layer (corresponding to the cathode electrode 11 in Example 6) on the surface of which the carbon film selective-growth region 20 is formed, and the electron emitting portion composed of the carbon film 23 formed on the carbon film selective-growth region 20. The above isotropic etching can be carried out by a dry etching method using a radical as a main etching species such as a chemical dry etching method, or a wet etching method using an etching solution. As an etching solution, for example, there can be used a 49% hydrofluoric acid aqueous solution/pure water mixture having a 49% hydrofluoric acid aqueous solution:pure water mixing ratio of 1:100 (volume ratio).

[Step-670]

Then, a display is assembled in the same manner as in [Step-130] in Example 1.

In the display having the above constitution, the electron emitting portion of the field emission device is composed of the flat carbon film 23 which is exposed in the bottom portion of the second opening portion 14B and has a low work function, and the fabrication thereof does not require such complicated and advanced fabrication techniques as have been required concerning the conventional Spindt type field emission device. Moreover, the etching of the carbon film 23 is no longer required. When the area of the effective field of a display increases and when the number of electron emitting portions to be formed increases accordingly to a great extent, the electron emission efficiency of the electron emitting portions can be rendered uniform throughout the entire region of the effective field, and there can be realized a display which is remarkably free of non-uniformity in brightness and has high image quality.

### EXAMPLE 7

Example 7 is directed to variants of the production method of the field emission device and the production method of the display explained in Example 6. In the production method of the field emission device and the production method of the display explained in Example 6, if the carbon film 23 is not formed immediately after the metal particles 21 are allowed to adhere onto the surface of the cathode electrode portion, the metal particles 21 are naturally oxidized to make it difficult to form the carbon film 23 in some cases. In Example 7, after the metal particles 21 are allowed to adhere onto the above surface of the portion of the cathode electrode 11, a metal oxide (so-called natural oxide film) on the surface of each metal particle 21 is removed. The metal oxide on the surface of each metal particle can be removed by plasma reduction treatment or washing.

The electron emission device, the field emission device and the display to be produced in Example 7 or any one of Examples 8 to 17 to be explained later are structurally the same as those in Example 6, so that detailed explanations thereof are omitted. The production method of the field emission device and the production method of the display in Example 7 will be explained below.

[Step-700]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-710]

Then, a mask layer 116 is formed so as to expose the surface of the cathode electrode 11 in a central portion of the bottom portion of the second opening portion 14B in the same manner as in [Step-640] in Example 6. Then, metal particles are allowed to adhere onto the mask layer 116 and the exposed surface of the cathode electrode 11. Specifically, a dispersion prepared by dispersing molybdenum (Mo) fine particles in a polysiloxane solution (using isopropyl alcohol as a solvent) is applied to the entire surface by a spin coating method, to form a layer composed of the solvent and the metal particles on the surface of the cathode electrode portion. Then, the mask layer 116 is removed, and the solvent is fully removed by heating the above layer up to approximately 400° C., to retain the metal particles 21 on the exposed surface of the cathode electrode 11, whereby the carbon film selective-growth region 20 can be obtained.

[Step-720]

Then, the metal oxide (natural oxide film) on the surface of each metal particle 21 is removed by plasma reduction treatment (microwave plasma treatment) under the condition shown in Table 8. Otherwise, the metal oxide (natural oxide film) on the surface of each metal particle 21 can be removed, for example, with a 50% hydrofluoric acid aqueous solution/pure water mixture having a 50% hydrofluoric acid aqueous solution:pure water mixing ratio of 1:49 (volume ratio).

[Step-730]

Then, the carbon film 23 having a thickness of approximately 0.2 μm is formed on the surface of the carbon film selective-growth region 20, to obtain an electron emitting portion. Table 13 shows a condition of forming the carbon film 23 according to a microwave plasma CVD method. In Example 7, the carbon film is stably formed at a film-forming temperature of 400° C.

TABLE 13
(Condition of forming carbon film)

| | |
|---|---|
| Gas used | CH₄/H₂ = 100/10 SCCM |
| Pressure | 1.3 × 10³ Pa |
| Microwave power | 500 W (13.56 Mz) |
| Film forming temperature | 400° C. |

[Step-740]

Then, a field emission device as shown in FIG. 11B can be obtained in the same manner as in [Step-660] in Example 6. Otherwise, there can be obtained an electron emission device which comprises the conductive layer (corresponding to the cathode electrode 11 in Example 7) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

### EXAMPLE 8

Example 8 is also directed to variants of the production method of the field emission device and the production method of the display explained in Example 6. In the production method of the field emission device and the production method of the display explained in Example 6, the metal particles 21 are allowed to adhere onto the surface of the cathode electrode portion. In Example 8, the metal particles 21 of cobalt (Co) are allowed to adhere onto the surface of the cathode electrode portion and then sulfur (S) is further allowed to adhere. The production method of a field emission device and the production method of a display in Example 8 will be explained below.

[Step-800]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-810]

Then, a mask layer 116 is formed so as to expose the surface of the cathode electrode 11 in a central portion of the bottom portion of the second opening portion 14B in the same manner as in [Step-640] in Example 6. Then, metal particles are allowed to adhere onto the mask material layer 116 and the exposed surface of the cathode electrode 11. Specifically, a dispersion prepared by dispersing cobalt (Co) fine particles in a polysiloxane solution is applied to the entire surface by a spin coating method in the same manner as in Example 6, to form a layer composed of the solvent and the metal particles on the surface of the cathode electrode portion. Then, a thionaphthene solution is applied to the entire surface by a spin coating method. Then, the mask layer 116 is removed, and the solvent is fully removed by heat treatment (for example, 300° C., 30 minutes) to retain the metal particles 21 on the exposed surface of the cathode electrode 11, and that suflur (S) could be allowed to adhere onto the surfce of the carbon film selective-growth region 20. As a result, the carbon film can be thereby further improved in selective growth property. There may be also employed a constitution in which the application and drying (heating) of the dispersion of cobalt (C) fine particles in a polysiloxane solution and the application and drying (heating) of the thionaphthene solution are carried out in this order, to retain the metal particles on the surface of the cathode electrode 11, whereby the carbon film selective-growth region 20 onto which sulfur adheres can be obtained. Thereafter, further, the metal oxide (natural oxide film) on the surface of each metal particle 21 may be removed in the same manner as in [Step-720] in Example 7.

[Step-820]

Then, the carbon film 23 having a thickness of approximately 0.2 μm is formed on the carbon film selective-growth region 20 in the same manner as in [Step-730] in Example 7, to obtain an electron emitting portion. Then, the field emission device as shown in FIG. 11B can be obtained in the same manner as in [Step-660] in Example 6. Otherwise, there can be obtained an electron emission device which comprises the conductive layer (corresponding to the cathode electrode 11 in Example 8) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

### EXAMPLE 9

Example 9 is also directed to variants of the production method of the field emission device and the production method of the display explained in Example 6. In the production method of the field emission device and the production method of the display explained in Example 6, the metal particles 21 are allowed to adhere onto the surface of the cathode electrode portion. In Example 9, the step of allowing the metal particles to the above surface of the cathode electrode portion comprises the steps of allowing metal compound particles containing a metal atom constituting the metal particles to adhere onto the surface of the cathode electrode portion, and then, heating the metal compound particles to decompose them, to obtain the carbon film selective-growth region constituted of the surface of the portion of the cathode electrode onto which surface the metal particles adhere. Specifically, a layer composed of a solvent and the metal compound particles (copper iodide in Example 9) is formed on the surface of the cathode electrode portion, then the solvent is removed to retain the metal compound particles, and the metal compound particles (copper iodide particles) are decomposed by heating, to obtain the carbon film selective-growth region constituted of that portion of the cathode electrode which portion has a surface onto which the metal particles (copper particles) adhere. The production method of the field emission device and the production method of the display in Example 9 will be explained below.

[Step-900]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-910]

Then, a mask layer 116 is formed so as to expose the surface of the cathode electrode 11 in a central portion of the bottom portion of the second opening portion 14B in the same manner as in [Step-640] in Example 6. Then, metal particles are allowed to adhere onto the exposed surface of the cathode electrode 11. Specifically, a dispersion prepared by dispersing copper iodide fine particles in a polysiloxane solution is applied to the entire surface by a spin coating method in the same manner as in Example 6, to form a layer composed of the solvent and the metal particles (copper iodide particles) on the surface of the cathode electrode portion. Then, the mask layer 116 is removed, and heat treatment is carried out at 400° C. to fully remove the solvent, to pyrolyze the copper iodide and to precipitate the metal particles (copper particles) 21 on the exposed surface of the cathode electrode 11, whereby the carbon film selective-growth region 20 can be obtained.

[Step-920]

Then, the carbon film 23 having a thickness of approximately 0.2 μm is formed on the carbon film selective-growth region 20 in the same manner as in [Step-730] in Example 7, to obtain an electron emitting portion. Then, a field emission device as shown in FIG. 11B can be obtained in the same manner as in [Step-660] in Example 6. Otherwise, there can be obtained an electron emission device which comprises the conductive layer (corresponding to the cathode electrode 11 in Example 9) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

Example 9 may also employ a constitution in which, after the dispersion of the copper iodide fine particles in a polysiloxane solution is applied to the entire surface by a spin coating method, for example, a thionaphthene solution is applied to the entire surface by a spin coating method, and heat treatment is carried out to fully remove the solvent and to pyrolyze the copper iodine. By this constitution, sulfur (S) can be allowed to adhere onto the surface of the carbon film selective-growth region 20. Further, the metal oxide (natural oxide film) on the surface of each metal particle 21 may be removed in the same manner as in [Step-720] in Example 7.

### EXAMPLE 10

Example 10 is also directed to variants of the production method of the field emission device and the production method of the display explained in Example 6. In the production method of the field emission device and the production method of the display explained in Example 6, the metal particles 21 are allowed to adhere onto the surface of the cathode electrode portion. In Example 10, the step of forming the carbon film selective-growth region comprises the steps of forming a mask layer so as to expose the surface of the cathode electrode in the bottom portion of the second opening portion and then forming a metal thin layer composed of titanium (Ti) on the mask layer and the exposed surface of the cathode electrode. The production method of the field emission device and the production method of the display in Example 10 will be explained below.

[Step-1000]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-1010]

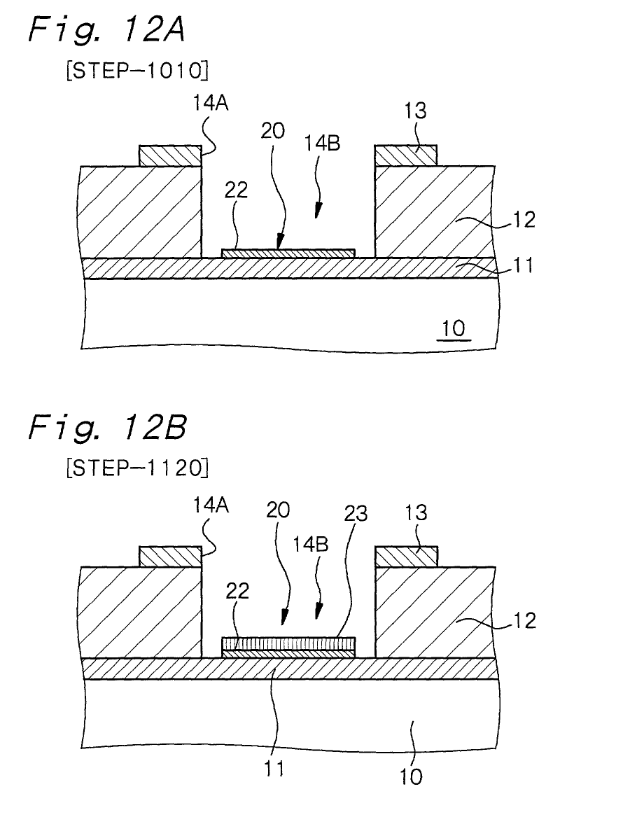

Then, a mask layer 116 is formed so as to expose the surface of the cathode electrode 11 in a central portion of the bottom portion of the second opening portion 14B in the same manner as in [Step-640] in Example 6. Then, a metal thin layer 22 is formed on the mask layer 116 and the exposed surface of the cathode electrode 11 by a sputtering method under the condition shown in Table 4, and then the mask layer 116 is removed (see FIG. 12A). In this manner, there can be obtained the carbon film selective-growth region 20 constituted of that portion of the cathode electrode which portion has the surface on which the metal thin layer 22 is formed.

[Step-1020]

Then, the carbon film 23 having a thickness of approximately 0.2 μm is formed on the carbon film selective-growth region 20 in the same manner as in [Step-730] in Example 7, to obtain an electron emitting portion (see FIG. 12B). Then, the field emission device can be completed in the same manner as in [Step-660] in Example 6. Otherwise, there can be obtained an electron emission device which comprises the conductive layer (corresponding to the cathode electrode 11 in Example 10) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 10, after the metal thin layer 22 is formed, the metal oxide (natural oxide film) on the surface of the metal thin layer 22 may be removed in the same manner as in [Step-720] in Example 7. Further, there may be employed a constitution in which, for example, a thionaphthene solution is applied to the entire surface by a spin coating method, and heat treatment is carried out to fully remove the solvent, whereby sulfur (S) can be allowed to adhere onto the surface of the carbon film selective-growth region 20, as is explained in [Step-810] in Example 8. Further, there may be employed a constitution in which, in the same manner as in Example 9, a metal compound thin layer is formed on the surface of the portion of the cathode electrode 11 which portion is positioned in the bottom portion of the second opening portion 14B, by a sputtering method, and the metal compound thin layer is pyrolyzed to form the carbon film selective-growth region 20 composed of the metal thin layer formed on the surface of the cathode electrode. Further, the metal thin layer may be formed by an MOCVD method.

### EXAMPLE 11

Example 11 is also directed to variants of the production method of the field emission device and the production method of the display explained in Example 6. In Example 11, the carbon film selective-growth region is composed of an organometallic compound thin layer, more specifically, composed of a complex compound of nickel acetylacetonate. In Example 11, further, the step of forming the organometallic compound thin layer on the surface of the cathode electrode portion comprises the step of applying an organometallic compound solution onto the cathode electrode. The production method of the field emission device and the production method of the display in Example 11 will be explained below.

[Step-1100]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-1110]

Then, a mask layer 116 is formed so as to expose the surface of the cathode electrode 11 in a central portion of the bottom portion of the second opening portion 14B in the same manner as in [Step-640] in Example 6. Then, a layer composed of an organometallic compound solution containing nickel acetylacetonate is formed on the mask layer 116 and the exposed surface of the cathode electrode 11 by a spin coating method, the applied organometallic compound solution is dried and then the mask layer 116 is removed, whereby there can be obtained the carbon film selective-growth region 20 composed of the organometallic compound thin layer which is formed on the surface of the portion of the cathode electrode which portion is exposed in the bottom portion of the opening portions 14A and 14B and which is composed of nickel acetylacetonate.

[Step-1120]

Then, the carbon film 23 having a thickness of approximately 0.2 μm is formed on the carbon film selective-growth region 20 in the same manner as in [Step-730] in Example 7, to obtain an electron emitting portion. Then, the field emission device can be completed in the same manner as in [Step-660] in Example 6. Otherwise, there can be obtained an electron emission device which comprises the conductive layer (corresponding to the cathode electrode 11 in Example 11) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 11, after the organometallic compound thin layer is formed, the metal oxide (natural oxide film) on the surface of the organometallic compound thin layer may be also removed in the same manner as in [Step-720] in Example 7. Further, there may be employed a constitution in which, for example, a thionaphthene solution is applied to the entire surface by a spin coating method in the same manner as in [Step-810] in Example 8, and then the solvent is fully removed by heat treatment, whereby sulfur (S) can be allowed to adhere onto the surface of the carbon film selective-growth region 20.

### EXAMPLE 12

Example 12 is also directed to variants of the production method of the field emission device and the production method of the display explained in Example 6 and further those of Example 11. In Example 12, the carbon film selective-growth region is composed of an organometallic compound thin layer, more specifically, is composed of a complex compound of nickel acetylacetonate. In Example 12, the step of forming the organometallic compound thin layer on the surface of the cathode electrode portion comprises the steps of sublimating an organometallic compound and then depositing such an organometallic compound on the cathode electrode. The production method of the field emission device and the production method of the display in Example 12 will be explained below.

[Step-1200]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-1210]

Then, a mask layer 116 is formed so as to expose the surface of the cathode electrode 11 in a central portion of the bottom portion of the second opening portion 14B in the same manner as in [Step-640] in Example 6. Then, an organometallic compound thin layer composed of nickel acetylacetonate is formed on the mask layer 116 and the exposed surface of the cathode electrode 11. Specifically, there is provided a film-forming apparatus having a reaction chamber and a sublimating chamber connected to the reaction chamber through a heatable tubing. The supporting substrate is transported into the reaction chamber, and then the reaction chamber is adjusted to have an inert gas atmosphere. Then, the nickel acetylacetonate is sublimated in the sublimation chamber, and the sublimated nickel acetylacetonate is sent to the reaction chamber together with a carrier gas. In the reaction chamber, an organometallic compound thin layer containing nickel acetylacetonate is deposited on the mask layer 116 and the exposed surface of the cathode electrode 11. The supporting substrate 10 can have a room temperature. Then, the mask layer 116 is removed to give the carbon film selective-growth region 20 composed of the organometallic compound thin layer which is formed on the surface of the portion of the cathode electrode 11 which portion is exposed in the bottom portion of the opening portions 14A and 14B and which is composed of nickel acetylacetonate.

[Step-1220]

Then, the carbon film 23 having a thickness of approximately 0.2 μm is formed on the carbon film selective-growth region 20 in the same manner as in [Step-730] in Example 7, to obtain an electron emitting portion (see FIG. 12B). Then, the field emission device can be completed in the same manner as in [Step-660] in Example 6. Otherwise, there can be obtained an electron emission device which comprises the conductive layer (corresponding to the cathode electrode 11 in Example 12) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 12, after the organometallic compound thin layer is formed, the metal oxide (natural oxide film) on the surface of the organometallic compound thin layer may be also removed in the same manner as in [Step-720] in Example 7. Further, there may be employed a constitution in which, for example, a thionaphthene solution is applied to the entire surface by a spin coating method, and then the solvent is fully removed by heat treatment, in the same manner as in [Step-810] in Example 8, whereby sulfur (S) can be allowed to adhere onto the surface of the carbon film selective-growth region 20.

### EXAMPLE 13

Example 13 is also directed to variants of the production method of the field emission device and the production method of the display explained in Example 6. In Example 13, the metal particle adhering onto the surface of the cathode electrode has an acicular form. Specifically, the metal particles are composed of copper (Cu). In Example 13, the step of adhering the metal particles onto the surface of the cathode electrode portion comprises the steps of sublimating a metallic compound and depositing acicular metal particles composed of a metal constituting the metallic compound on the surface of the cathode electrode portion. The production method of the field emission device and the production method of the display in Example 13 will be explained below.

[Step-1300]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12. Preferably, the material constituting the cathode electrode and the material constituting the metal particles have the same lattice constants or the same crystal structures. That is, the cathode electrode and the metal particles are preferably composed of the same material. In Example 13, therefore, the cathode electrode 11 is composed of copper (Cu).

[Step-1310]

Then, a mask layer is formed so as to expose the surface of the cathode electrode 11 in a central portion of the bottom portion of the second opening portion 14B. Then, the metallic compound is sublimated to deposit acicular metal particles composed of a metal (specifically, copper) constituting the metallic compound on the surface of the cathode electrode portion. Specifically, there is provided a film-forming apparatus having a reaction chamber and a sublimating chamber connected to the reaction chamber through a heatable tubing. The supporting substrate is transported into the reaction chamber, and then the reaction chamber is adjusted to have a reducing gas atmosphere (for example, a hydrogen gas atmosphere). And, in the sublimation chamber, cupric chloride (CuCl₂) is sublimated at 425° C. and the sublimated cupric chloride is sent to the reaction chamber together with a carrier gas (for example, hydrogen gas). In the reaction chamber, the supporting substrate is heated to approximately 450° C., whereby acicular metal particles composed of copper are deposited on the exposed surface of the cathode electrode 11. Then, the mask layer is removed, to give the carbon film selective-growth region 20 which is formed on the surface of the portion of the cathode electrode 11 which portion is exposed in the bottom portion of the opening portions 14A and 14B and which is composed of acicular metal particles composed of copper. The acicular metal particles have a diameter of 100 nm or less and have nearly uniform heights.

[Step-1320]

The carbon film 23 having a thickness of approximately 0.2 μm is formed on the carbon film selective-growth region 20 by a CVD method using a diode parallel plate plasma enhanced CVD system under a condition shown in Table 14, to obtain an electron emitting portion. Under a conventional carbon film formation condition, a film forming temperature of approximately 900° C. has been required. In Example 13, however, the carbon film selective-growth region 20 is composed of the acicular metal particles, so that convexo-concave shapes (protrusions) are formed in the carbon film 23, and therefore, a field emission device having high electron emission efficiency can be obtained even under the condition shown in Table 14, that is, even if the temperature for forming the carbon film is set at 300° C.

TABLE 14
(Condition of forming carbon film)

| | |
|---|---|
| Gas used | CH₄/H₂ = 100/10 SCCM |
| Pressure | 1.3 × 10³ Pa |
| Microwave power | 500 W (13.56 Mz) |
| Film forming temperature | 300° C. |

[Step-1330]

Then, the field emission device can be completed in the same manner as in [Step-660] in Example 6. Otherwise, there can be obtained an electron emission device which comprises the conductive layer (corresponding to the cathode electrode 11 in Example 13) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 13, after the metal particles are formed, the metal oxide (natural oxide film) on the surface of each metal particle may be also removed in the same manner as in [Step-720] in Example 7. Further, there may be employed a constitution in which, for example, a thionaphthene solution is applied to the entire surface by a spin coating method, and then the solvent is fully removed by heat treatment, in the same manner as in [Step-810] in Example 8, whereby sulfur (S) can be allowed to adhere onto the surface of the carbon film selective-growth region 20.

### EXAMPLE 14

Example 14 is directed to a variant of Example 13. In Example 14, specifically, the metal particles are composed of iron (Fe). The production method of the field emission device and the production method of the display in Example 14 will be explained below.

[Step-1400]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12. In Example 14, the cathode electrode 11 is composed of iron (Fe).

[Step-1410]

Then, a mask layer is formed so as to expose the surface of the cathode electrode 11 in a central portion of the bottom portion of the second opening portion 14B. Then, the metallic compound is sublimated to deposit acicular metal particles composed of a metal (specifically, iron) constituting the metallic compound on the surface of the cathode electrode portion. Specifically, there is provided a film-forming apparatus having a reaction chamber and a sublimating chamber connected to the reaction chamber through a heatable tubing. The supporting substrate is transported into the reaction chamber, and then the reaction chamber is adjusted to have a reducing gas atmosphere (for example, a hydrogen gas atmosphere). And, in the sublimation chamber, ferric chloride (FeCl₃) is sublimated at 400° C. and the sublimated ferric chloride is sent to the reaction chamber together with a carrier gas (for example, hydrogen gas). In the reaction chamber, the supporting substrate is heated to approximately 400° C., whereby acicular metal particles composed of iron are deposited on the exposed surface of the cathode electrode 11. Then, the mask layer is removed, to give a carbon film selective-growth region 20 which is formed on the surface of the portion of the cathode electrode 11 which portion is exposed in the bottom portion of the opening portions 14A and 14B and which is composed of acicular metal particles composed of iron. The acicular metal particles have a diameter of 100 nm or less and have nearly uniform heights.

[Step-1420]

The carbon film 23 having a thickness of approximately 0.2 μm is formed on the carbon film selective-growth region 20 by a CVD method using a diode parallel plate plasma enhanced CVD system under a condition shown in Table 15, to obtain an electron emitting portion. Under a conventional carbon film formation condition, a film forming temperature of approximately 900° C. has been required. In Example 14, however, the carbon film selective-growth region 20 is composed of the acicular metal particles, so that convexo-concave shapes (protrusions) are formed in the carbon film, and therefore, a field emission device having high electron emission efficiency can be obtained even under the condition shown in Table 15, that is, even if the temperature for forming the carbon film is set at 300° C.

TABLE 15
(Condition of forming carbon film)

| | |
|---|---|
| Gas used | C₂H₄/H₂ = 100/10 SCCM |
| Pressure | 1.3 × 10³ Pa |
| Microwave power | 500 W (13.56 Mz) |
| Film forming temperature | 300° C. |

[Step-1430]

Then, the field emission device can be completed in the same manner as in [Step-660] in Example 6. Otherwise, there can be obtained an electron emission device which comprises the conductive layer (corresponding to the cathode electrode 11 in Example 14) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 14, after the metal particles are formed, the metal oxide (natural oxide film) on the surface of each metal particle may be also removed in the same manner as in [Step-720] in Example 7. Further, there may be employed a constitution in which, for example, a thionaphthene solution is applied to the entire surface by a spin coating method, and then the solvent is fully removed by heat treatment, in the same manner as in [Step-810] in Example 8, whereby sulfur (S) can be allowed to adhere onto the surface of the carbon film selective-growth region 20.

### EXAMPLE 15

Example 15 is also directed to variants of the production method of the field emission device and the production method of the display explained in Example 6. In Example 15, the carbon film selective-growth region composed of a metal thin layer is formed on the surface of the cathode electrode by a plating method. The production method of the field emission device and the production method of the display in Example 15 will be explained below.

[Step-1500]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-1510]

Then, a mask layer 116 is formed so as to expose the surface of the cathode electrode 11 in a central portion of the bottom portion of the second opening portion 14B in the same manner as in [Step-640] in Example 6. Then, the carbon film selective-growth region 20 composed of a metal thin layer is formed on the exposed surface of the cathode electrode 11 by a plating method. Specifically, the supporting substrate is immersed in a zinc plating solution bath, and the carbon film selective-growth region 20 constituted of a metal thin layer composed of zinc (Zn) is formed on the exposed surface of the cathode electrode 11 by a zinc plating method in which the cathode electrode 11 is connected to a cathode side and nickel as an anticathode is connected to an anode side. For reliably prevent the deposition of a zinc layer on the gate electrode, it is preferred to connect the gate electrode 13 to the anode side. Then, the mask layer 116 is removed using an organic solvent such as acetone, to give the carbon film selective-growth region 20 which is constituted of a metal thin layer composed of zinc (Zn) and is formed on the surface of the portion of the cathode electrode 11 which portion is exposed in the bottom portion of the opening portions 14A and 14B. If the zinc plating solution bath is replaced with a tin plating solution bath, there can be obtained a carbon film selective-growth region 20 constituted of a metal thin layer composed of tin (Sn).

[Step-1520]

Then, the carbon film 23 having a thickness of approximately 0.2 μm is formed on the carbon film selective-growth region 20 by a CVD method using a diode parallel plate plasma enhanced CVD system under the condition shown in Table 14, to obtain an electron emitting portion.

[Step-1530]

Then, the field emission device can be completed in the same manner as in [Step-660] in Example 6. Otherwise, there can be obtained an electron emission device which comprises the conductive layer (corresponding to the cathode electrode 11 in Example 15) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 15, after the metal thin layer is formed, the metal oxide (natural oxide film) on the surface of the metal thin layer may be also removed in the same manner as in [Step-720] in Example 7. When the above treatment is carried out, the carbon film could be formed under the condition shown in Table 11. Further, there may be employed a constitution in which, for example, a thionaphthene solution is applied to the entire surface by a spin coating method, and then the solvent is fully removed by heat treatment, in the same manner as in [Step-810] in Example 8, whereby sulfur (S) can be allowed to adhere onto the surface of the carbon film selective-growth region 20.

### EXAMPLE 16

Example 16 is a variant of Example 15. In Example 16, a convexo-concave shape is formed in the surface of the portion of the carbon film selective-growth region formed on the surface of the portion of the cathode electrode 11 which portion is exposed in the bottom portion of the opening portions 14A and 14B. AS a result, the carbon film formed thereon has protrusions, so that a field emission device having high electron emission efficiency can be obtained. The production method of the field emission device and the production method of the display in Example 16 will be explained below.

[Step-1600]

In the same manner as in [Step-1500] to [Step-1510] in Example 15, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12. A mask layer 116 is then formed so as to expose the surface of the cathode electrode 11 in a central portion of the bottom portion of the second opening portion 14B in the same manner as in [Step-640] in Example 6. Then, a carbon film selective-growth region 20 constituted of a metal thin layer composed of zinc (Zn) is formed on the exposed surface of the cathode electrode 11 by a plating method.

[Step-1610]

Then, the supporting substrate 10 is immersed in a 5% sodium hydroxide aqueous solution, to etch the surface of the carbon film selective-growth region 20 constituted of the metal thin layer composed of zinc (Zn), whereby a convexo-concave shape is formed in the surface of the carbon film selective-growth region 20.

[Step-1620]

Then, the carbon film 23 having a thickness of approximately 0.2 μm is formed on the carbon film selective-growth region 20 by a CVD method using a diode parallel plate plasma enhanced CVD system under a condition shown in Table 16, to obtain an electron emitting portion.

TABLE 16
(Condition of forming carbon film)

| | |
|---|---|
| Gas used | C₂H₄/H₂ = 100/10 SCCM |
| Pressure | 7 × 10² Pa |
| Microwave power | 700 W (13.56 Mz) |
| Film forming temperature | 200° C. |

[Step-1630]

Then, the field emission device can be completed in the same manner as in [Step-660] in Example 6. Otherwise, there can be obtained an electron emission device which comprises the conductive layer (corresponding to the cathode electrode 11 in Example 16) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 16, after the metal thin layer is formed, the metal oxide (natural oxide film) on the surface of the metal thin layer may be also removed in the same manner as in [Step-720] in Example 7. Further, there may be employed a constitution in which, for example, a thionaphthene solution is applied to the entire surface by a spin coating method, and then the solvent is fully removed by heat treatment, in the same manner as in [Step-810] in Example 8, whereby sulfur (S) can be allowed to adhere onto the surface of the carbon film selective-growth region 20. Further, for forming the convexo-concave shape in the surface of the carbon film selective-growth region 20, not only a sodium hydroxide aqueous solution is used, but also diluted hydrochloric acid, diluted sulfuric acid or diluted nitric acid may be used depending upon materials constituting the carbon film selective-growth region 20.

### EXAMPLE 17

Example 17 is also directed to variants of the production method of the field emission device and the production method of the display explained in Example 6. In Example 17, the carbon film selective-growth region composed of a metal thin layer is formed on the surface of the cathode electrode by a method in which an organometallic compound is pyrolyzed. The production method of the field emission device and the production method of the display in Example 17 will be explained below.

[Step-1700]

In the same manner as in [Step-600] to [Step-630] in Example 6, a cathode electrode 11 is formed on a supporting substrate 10 made, for example, of a glass substrate; then, an insulating layer 12 is formed on the supporting substrate 10 and the cathode electrode 11; then, a gate electrode 13 having a first opening portion 14A is formed on the insulating layer 12; and then, a second opening portion 14B communication with the first opening portion 14A formed in the gate electrode 13 is formed in the insulating layer 12.

[Step-1710]

Then, a mask layer 116 is formed so as to expose the surface of the cathode electrode 11 in a central portion of the bottom portion of the second opening portion 14B in the same manner as in [Step-640] in Example 6. Then, the carbon film selective-growth region 20 composed of a metal thin layer is formed on the mask layer 116 and the exposed surface of the cathode electrode 11 by a method in which nickel acetylacetonate is pyrolyzed. Specifically, there is provided a film-forming apparatus having a reaction chamber and a sublimating chamber connected to the reaction chamber through a heatable tubing. The supporting substrate is transported into the reaction chamber, and then the reaction chamber is adjusted to have an inert gas atmosphere. Then, the nickel acetylacetonate is sublimated in the sublimation chamber, and the sublimated nickel acetylacetonate is sent to the reaction chamber together with a carrier gas. The supporting substrate is maintained at a proper temperature in advance. The supporting substrate is preferably heated at 50 to 300° C., preferably at 100 to 200° C. In the reaction chamber, a nickel (Ni) layer obtained by the pyrolysis of nickel acetyulacetonate is deposited on the mask layer 116 and the exposed surface of the cathode electrode 11. Then, the mask layer 116 is removed to give a carbon film selective-growth region 20 composed of the metal thin layer which is composed of nickel (N) and is formed on the surface of the portion of the cathode electrode 11 which portion is exposed in the bottom portion of the opening portions 14A and 14B.

Alternatively, for example, an organometallic compound solution containing zinc (Zn) is applied, by a spin coating method, to the entire surface of the mask layer 116 and the surface of the cathode electrode 11 which surface is exposed in the central portion of the bottom portion of the second opening portion 14B, and the resultant coating is heat-treated in a reducing gas atmosphere, to pyrolyze the organometallic compound containing zinc and to form a zinc (Zn) layer on the mask layer and the exposed surface of the cathode electrode 11, whereby the carbon film selective-growth region 20 constituted of a metal thin layer composed of zinc (Zn) can be also obtained.

[Step-1720]

Then, the carbon film having a thickness of approximately 0.2 μm is formed on the carbon film selective-growth region 20 in the same manner as in [Step-730] in Example 7, to obtain an electron emitting portion. Then, the field emission device can be completed in the same manner as in [Step-660] in Example 6. Otherwise, there can be obtained an electron emission device which comprises the conductive layer (corresponding to the cathode electrode 11 in Example 17) on the surface of which the carbon film selective-growth region 20 is formed, and the electron emitting portion composed of the carbon film 23 formed on the carbon film selective-growth region 20. Further, a display is assembled in the same manner as in [Step-130] in Example 1.

In Example 17, after the metal thin layer is formed, the metal oxide (natural oxide film) on the surface of the metal thin layer may be also removed in the same manner as in [Step-720] in Example 7. Further, there may be employed a constitution in which, for example, a thionaphthene solution is applied to the entire surface by a spin coating method, and then the solvent is fully removed by heat treatment, in the same manner as in [Step-810] in Example 8, whereby sulfur (S) can be allowed to adhere onto the surface of the carbon film selective-growth region 20.

### EXAMPLE 18

Example 18 is directed to the electron emission device of the present invention, the field emission device according to the second aspect of the present invention, the display according to the third aspect of the present invention and the production method according to the second aspect of the present invention.

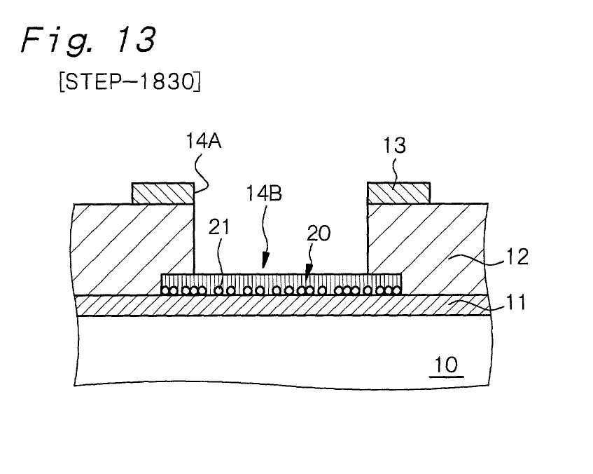

FIG. 13 shows a schematic partial end view of the field emission device of Example 18. The field emission device also comprises a cathode electrode 11 formed on a supporting substrate 10 and a gate electrode 13 which is formed above the cathode electrode 11 and has a first opening portion 14A. The field emission device further has a carbon film selective-growth region 20 formed on a surface of a portion of the cathode electrode 11 which portion is positioned in a bottom portion of opening portions 14A and 14B, and an electron emitting portion composed of a carbon film 23 formed on the carbon film selective-growth region 20. In Example 18, the carbon film selective-growth region 20 is that portion of the cathode electrode 11 onto a surface of which portion metal particles 21 composed of nickel (Ni) adhere. Differing from those of the field emission devices explained in Examples 6 to 17, the carbon film selective-growth region 20 and the carbon film 23 formed thereon extend to reach an interior of an insulating layer 12. In some formation state of the carbon film selective-growth region 20, however, the carbon film selective-growth region 20 and the carbon film 23 formed thereon may be formed only on the surface of the portion of the cathode electrode 11 which portion is positioned in the bottom of the opening portions 14A and 14B like those of the field emission devices explained in Examples 6 to 17.

In the field emission device of Example 18, the insulating layer 12 is formed on the supporting substrate 10 and the cathode electrode 11, the second opening portion 14B communication with the first opening portion 14A formed in the gate electrode 13 is formed in the insulating layer 12, and the carbon film 23 is positioned in the bottom portion of the second opening portion 14B.

The display of Example 18 is substantially similar to the display shown in FIG. 8, so that a detailed explanation thereof is omitted.

The production method of the field emission device and the production method of the display in Example 8 will be explained below with reference to FIGS. 3A and 3D and FIG. 13.

[Step-1800]

In the same manner as in [Step-100] in Example 1, an electrically conductive material layer for a cathode electrode is formed on a supporting substrate 10 made, for example, of glass, and the electrically conductive material layer is patterned by known lithography and a known RIE method, to form the cathode electrode 11 in the form of a strip on the supporting substrate 10 (see FIG. 3A). The cathode electrode 11 in the form of a stripe extends leftward and rightward on the paper surface of the drawing. The electrically conductive material layer is composed, for example, of an approximately 0.2 μm thick chromium (Cr) layer formed by a sputtering method.

[Step-1810]

Then, the carbon film selective-growth region 20 is formed on the surface of the cathode electrode 11 in the same manner as in [Step-110] in Example 1.

[Step-1820]

Then, a carbon film 23 having a thickness of approximately 0.2 μm is formed on the carbon film selective-growth region 20, to obtain an electron emitting portion. FIG. 3D shows the thus-obtained state. The carbon film 23 can be formed by a microwave plasma CVD method under the condition shown in Table 12.

[Step-1830]

Then, the gate electrode 13 having the first opening portion 14A is formed above the carbon film 23. Specifically, the insulating layer 12 is formed on the entire surface in the same manner as in [Step-610] in Example 6, and the gate electrode 13 having the first opening portion 14A is formed on the insulating layer 12 in the same manner as in [Step-620] in Example 6. Then, the second opening portion 14B communicating with the first opening portion 14A formed in the gate electrode 13 is formed in the insulating layer 12 in the same manner as in [Step-630] in Example 6, to expose the carbon film 23 in the bottom portion of the second opening portion 14B. In Example 18, the first opening portion 14A and the second opening portion 14B have a one-to-one correspondence relationship as well. That is, one second opening portion 14B is formed per first opening portion 14A. When viewed as a plan view, the first and second opening portions 14A and 14B have the form, for example, of a circle having a diameter of 1 to 30 μm. It is sufficient to form the opening portions 14A and 14B, for example, in the quantity of approximately 1 to 3000 per pixel. In this manner, the field emission device shown in FIG. 13 can be obtained.

[Step-1840]

For exposing an opening end portion of the gate electrode 13, preferably, the side wall surface of the second opening portion 14B formed in the insulating layer 12 is allowed to recede by isotropic etching in the same manner as in [Step-660] in Example 6. Then, a display is assembled in the same manner as in [Step-130] in Example 1.

### EXAMPLE 19

Example 19 is directed to the electron emission device of the present invention, the field emission device according to the second aspect of the present invention, the display according to the third aspect of the present invention and the production method according to the third aspect of the present invention.

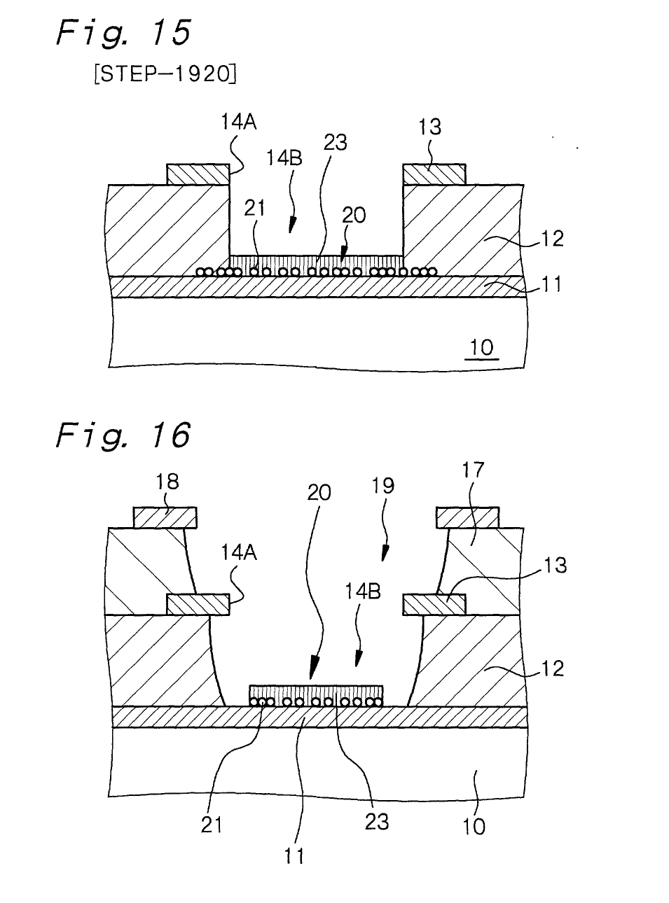

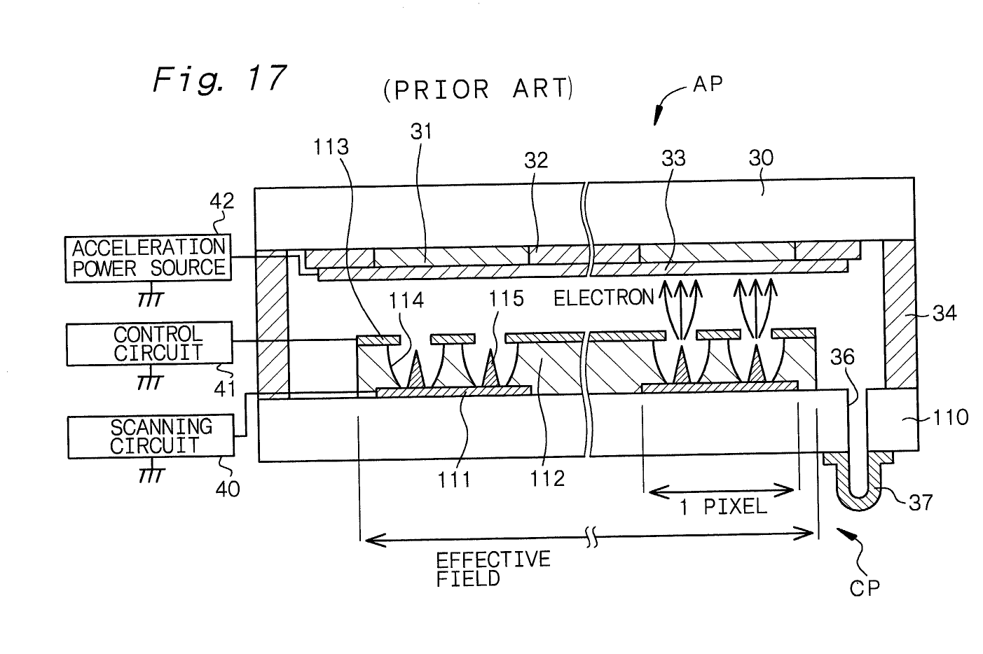

FIG. 15 shows a schematic partial end view of the field emission device of Example 19. The field emission device is substantially structurally the same as the field emission device explained in Example 18, so that a detailed explanation thereof is omitted. Further, the display of Example 19 is substantially similar to the display shown in FIG. 8, so that a detailed explanation thereof is omitted.

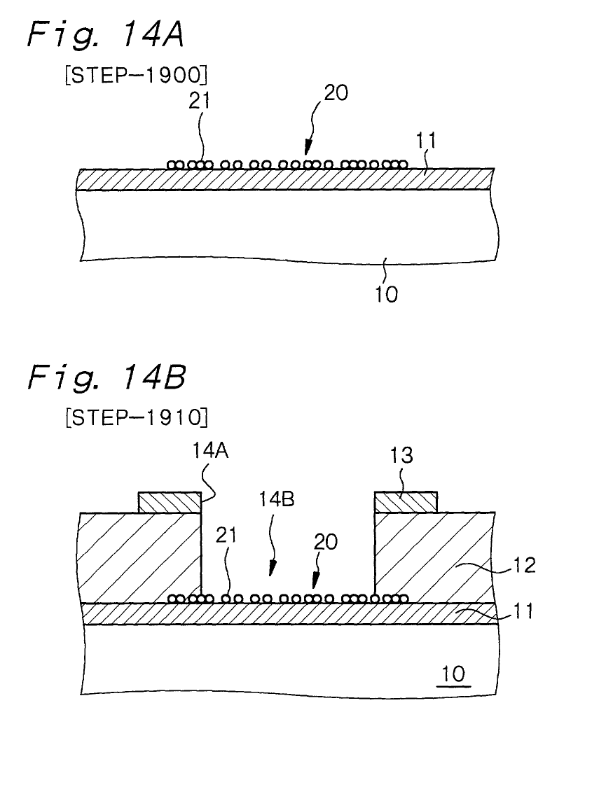

The production method of the field emission device and the production method of the display in Example 19 will be explained below with reference to FIGS. 14A, 14B and 15.

[Step-1900]

First, a cathode electrode 11 in the form of a stripe is formed on a supporting substrate 10 made, for example, of glass in the same manner as in [Step-1800] in Example 18. Then, a carbon film selective-growth region 20 is formed in a surface of the cathode electrode 11 in the same manner as in [Step-1810] in Example 18 (see FIG. 14A).

[Step-1910]

Then, the gate electrode 13 having the first opening portion 14A is formed above the carbon film selective-growth region 20 in the same manner as in [Step-1830] in Example 18. Specifically, the insulating layer 12 is formed on the entire surface in the same manner as in [Step-610] in Example 6, and the gate electrode 13 having the first opening portion 14A is formed on the insulating layer 12 in the same manner as in [Step-620] in Example 6. Then, the second opening portion 14B communicating with the first opening portion 14A formed in the gate electrode 13 is formed in the insulating layer 12 in the same manner as in [Step-630] in Example 6, to expose the carbon film selective-growth region 20 in the bottom portion of the second opening portion 14B. In Example 19, the first opening portion 14A and the second opening portion 14B have a one-to-one correspondence relationship as well. That is, one second opening portion 14B is formed per first opening portion 14A. When viewed as a plan view, the first and second opening portions 14A and 14B have the form, for example, of a circle having a diameter of 1 to 30 μm. It is sufficient to form the opening portions 14A and 14B, for example, in the quantity of approximately 1 to 3000 per pixel. In this manner, the structure shown in FIG. 14B can be obtained.

[Step-1920]

A carbon film 23 having a thickness of approximately 0.2 μm is formed on the carbon film selective-growth region 20 in the same manner as in [Step-650] in Example 6, to give an electron emitting portion (see FIG. 15).

[Step-1930]

Then, for exposing an opening end portion of the gate electrode 13, preferably, the side wall surface of the second opening portion 14B formed in the insulating layer 12 is allowed to recede by isotropic etching in the same manner as in [Step-660] in Example 6. Then, a display is assembled in the same manner as in [Step-130] in Example 1.

In Example 18 or 19, after the formation of the opening portion 14A and 14B, the metal oxide (natural oxide film) on the surface of each metal particle or on the surface of the metal thin layer in the exposed carbon film selective-growth region 20 may be removed as described in [Step-720] in Example 7. As explained in [Step-810] in Example 8, there may be employed a constitution in which, after, for example, a thionaphthene solution is applied to the entire surface by a spin coating method, heat treatment is be carried out to allow sulfur (S) to adhere onto the surface of the carbon film selective-growth region 20. Further, as described in Example 9, there may be employed a constitution in which the metallic compound particles are allowed to adhere or the metallic compound thin layer is formed, and then the metallic compound particles or the metallic compound thin layer is pyrolyzed to obtain a carbon film selective-growth region 20 composed of the metal particles adhering onto the surface of the cathode electrode or a metal thin layer formed thereon.

Further, in Example 18 or 19, as described in Example 10, the step of forming the carbon film selective-growth region may comprise the steps of forming a mask layer so as to expose the surface of the cathode electrode in a central portion of the bottom portion of the second opening portion and forming a metal thin layer on the mask layer and the exposed surface of the cathode electrode by a sputtering method. In Example 18 or 19, as described in Example 11 or 12, the step of forming the carbon film selective-growth region may comprise the step of forming, on the cathode electrode, a layer from an organometallic compound solution, or may comprise the steps of sublimating an organometallic compound and then depositing such an organometallic compound on the cathode electrode. In Example 18 or 19, as described in Example 13 or 14, further, the step of allowing the metal particles to adhere onto the surface of the cathode electrode portion may be the steps of sublimating a metallic compound and depositing acicular metal particles composed of the metal constituting the metal compound on the above surface of the cathode electrode portion. Furthermore, in Example 18 or 19, as described in Example 15 or 16, the carbon film selective-growth region composed of a metal thin layer may be formed on the surface of the cathode electrode by a plating method, and as described in Example 17, the carbon film selective-growth region composed of a metal thin layer may be formed on the surface of the cathode electrode by a method in which an organometallic compound is pyrolyzed.

While the present invention has been explained with reference to Examples hereinabove, the present invention shall not be limited thereto. Those various conditions, materials and structures of the field emission device and the display explained in Examples are given for illustrative purposes and may be altered as required.

For forming the gate electrode, there may be employed other method in which a metal layer which is in the form of a band and has a plurality of opening portions formed therein is provided in advance, a gate electrode supporting members composed of an insulating material in the form of, for example, a band are formed on the supporting substrate 10 in advance, and the metal layer is arranged above the carbon film or the carbon film selective-growth region such that the metal layer is in contact with the top surfaces of the gate electrode supporting members. In this case, the carbon film selective-growth region and the carbon film may be formed before the arrangement of the gate electrode, or the carbon film selective-growth region and the carbon film may be formed after the arrangement of the gate electrode. Otherwise, the carbon film selective-growth region may be formed before the arrangement of the gate electrode and the carbon film may be formed after the arrangement of the gate electrode. In these cases, the carbon film selective-growth region 20 may not be formed right below the first opening portion 14A. In these case, there is employed a structure in which one second opening portion is formed for a plurality of the first opening portions 14A and one carbon film selective-growth region 20 is formed in the bottom portion of the second opening portion.

The cold cathode field emission device of the present invention may have a constitution in which a second insulating layer 17 is further formed in the gate electrode 13 and the insulating layer 12, and a focus electrode 18 is formed on the second insulating layer 17. FIG. 16 shows a schematic partial end view of the thus-constituted field emission device. The second insulating layer 17 has a third opening portion 19 communicating with the opening portion 14A. The focus electrode 18 may be formed as follows. For example, in [Step-610] in Example 6, the gate electrode 13 in the form of a stripe is formed on the insulating layer 12, then, the second insulating layer 17 is formed, then, a patterned focus electrode 18 is formed on the second insulating layer 17, the third opening portion 19 is formed in the focus electrode 18 and the second insulating layer 17, and further, the first opening portion 14A is formed in the gate electrode 13.

The electron emission device of the present invention can be applied to a device generally called a surface conduction type electron emission device. The above surface conduction type electron emission device comprises a supporting substrate made, for example, of glass and pairs of electrodes formed on the supporting substrate. The electrode is composed of an electrically conductive material such as tin oxide (SnO₂), gold (Au), indium oxide (In₂O₃)/tin oxide (SnO₂), carbon, palladium oxide (PdO), etc. The pair of the electrodes has a very small area and is arranged at a predetermined interval (gap). The pairs of the electrodes are formed in the form of a matrix. And, the surface conduction type electron emission device has a constitution in which a wiring in the row direction is connected to one of each pair of the electrodes and a wiring in the column direction is connected to the other of each pair of the electrodes. In the above surface conduction type electron emission device, a carbon film selective-growth region is formed on the surface of each pair of the electrodes (corresponding to the conductive layer), and the electron emitting portion composed of the carbon film is formed on the carbon film selective-growth region. When a voltage is applied to a pair of the electrodes, an electric field is exerted on the carbon films opposed to each other through the gap, and electrons are emitted from the carbon film. Such electrons are attracted toward the anode panel to collide with the fluorescent layer on the anode panel, so that the fluorescent layer is excited to emit light and gives a desired image.

In the present invention, the electron emitting portion composed of the carbon film is formed in a desired portion of the conductive layer or the cathode electrode, and it is no longer necessary to pattern the carbon film in a desired form. Further, the electron emitting portion being composed of the carbon film has a low threshold voltage and can give a cold cathode field emission device having high electron emission efficiency. Further, there can be obtained a cold cathode field emission display having the performances of low power consumption and quality images. When the effective field increases in area and when the number of cold cathode field emission devices accordingly increases to a great extent, the electron emitting portion for each cold cathode field emission device can be formed with good accuracy, so that uniform electron emission efficiency of the cold cathode field emission devices is attained over the entire region of the effective field, and that cold cathode field emission displays having the performances of remarkable freedom of non-uniformity in brightness and high quality images can be produced. Moreover, the carbon film can be formed at a relatively low temperature, so that a glass substrate can be used as a supporting substrate, and the production cost for the display can be decreased.

What is claimed is:

1. An electron emission device comprising;
(a) a conductive layer with a carbon film selective-growth region formed on a surface thereof, and
(b) an electron emitting portion composed of a carbon film formed on the carbon film selective-growth region.

2. A cold cathode field emission device comprising;
(a) a cathode electrode formed on a supporting substrate, and
(b) a gate electrode which is formed above the cathode electrode and has an opening portion,
and further comprising;
(c) an electron emitting portion composed of a carbon film formed on a surface of a portion of the cathode electrode which portion is positioned in a bottom portion of the opening portion.

3. The cold cathode field emission device according to claim 2, in which the cathode electrode is composed of copper, silver or gold.

4. The cold cathode field emission device according to claim 2, in which an insulating layer is formed on the supporting substrate and the cathode electrode, and a second opening portion communicating with the opening portion formed in the gate electrode is formed in the insulating layer.

5. A cold cathode field emission device comprising;
(a) a cathode electrode formed on a supporting substrate, and
(b) a gate electrode which is formed above the cathode electrode and has an opening portion,
and further comprising;
(c) a carbon film selective-growth region formed at least on a surface of a portion of the cathode electrode which portion is positioned in a bottom portion of the opening portion, and
(d) an electron emitting portion composed of a carbon film formed on the carbon film selective-growth region.

6. The cold cathode field emission device according to claim 5, in which the carbon film selective-growth region is that portion of the cathode electrode onto the surface of which portion metal particles adhere, or that portion of the cathode electrode on the surface of which portion a metal thin layer or an organometallic compound thin layer is formed.

7. The cold cathode field emission device according to claim 6, in which the metal particles are or the metal thin layer is composed of at least one metal selected from the group consisting of molybdenum, nickel, titanium, chromium, cobalt, tungsten, zirconium, tantalum, iron, copper, platinum, zinc, cadmium, mercury, germanium, tin, lead, bismuth, silver, gold, indium and thallium.

8. The cold cathode field emission device according to claim 6, in which the surface of the carbon film selective-growth region has sulfur, boron or phosphorus adhering thereto.

9. The cold cathode field emission device according to claim 6, in which the organometallic compound thin layer is formed from an organometallic compound containing at least one element selected from the group consisting of zinc, tin, aluminum, lead, nickel and cobalt.

10. The cold cathode field emission device according to claim 9, in which the organometallic compound thin layer is composed of a complex compound.

11. The cold cathode field emission device according to claim 5, in which an insulating layer is formed on the supporting substrate and the cathode electrode, a second opening portion communicating with the opening portion formed in the gate electrode is formed in the insulating layer, and the carbon film is positioned in a bottom portion of the second opening portion.

12. The cold cathode field emission device according to claim 6, in which the metal particles adhering onto the surface of the cathode electrode have an acicular form.

13. The cold cathode field emission device according to claim 12, in which the acicular metal particles are composed of at least one metal selected from the group consisting of copper, iron, tungsten, tantalum, titanium and zirconium.

14. A method for the production of a cold cathode field emission device, comprising the steps of;
(A) forming a cathode electrode on a supporting substrate,
(B) forming an insulating layer on the supporting substrate and the cathode electrode,
(C) forming a gate electrode having an opening portion on the insulating layer,
(D) forming, in the insulating layer, a second opening portion communicating with the opening portion formed in the gate electrode,
(E) forming a carbon film selective-growth region on a surface of a portion of the cathode electrode which portion is positioned in a bottom portion of the second opening portion, and
(F) forming a carbon film on the carbon film selective-growth region.

15. The method for the production of a cold cathode field emission device according to claim 14, in which the carbon film selective-growth region formation step comprises the steps of forming a mask layer with a surface of the cathode electrode which surface is exposed in a central portion of the bottom portion of the second opening portion, and then allowing metal particles to adhere onto, or forming a metal thin layer or an organometallic compound thin layer on, the mask layer and the exposed surface of the cathode electrode.

16. The method for the production of a cold cathode field emission device according to claim 14, in which the carbon film selective-growth region formation step comprises the step of allowing metal particles to adhere onto, or forming a metal thin layer or an organometallic compound thin layer on, the surface of the portion of the cathode electrode in which portion the carbon film selective-growth region is to be formed, whereby formed is the carbon film selective-growth region constituted of the portion of the cathode electrode which portion has the surface onto which the metal particles adhere or on which the metal thin layer or the organometallic compound thin layer is formed.

17. The method for the production of a cold cathode field emission device according to claim 16, further including the step of adhering sulfur, boron or phosphorus onto the surface of the carbon film selective-growth region.

18. The method for the production of a cold cathode field emission device according to claim 16, in which after the metal particles are allowed to adhere onto, or the metal thin layer or the organometallic compound thin layer is formed on, the surface of the cathode electrode, a metal oxide on the surface of each metal particle or on the surface of the metal thin layer or the organometallic compound thin layer is removed.

19. The method for the production of a cold cathode field emission device according to claim 18, in which the metal oxide on the surface of each metal particle or on the surface of the metal thin layer or the organometallic compound thin layer is removed by plasma reduction treatment or by washing.

20. The method for the production of a cold cathode field emission device according to claim 16, in which the step for allowing the metal particles to adhere onto the surface of the portion of the cathode electrode in which portion the carbon film selective-growth region is to be formed comprises the steps of forming a layer composed of a solvent and the metal particles on the surface of the portion of the cathode electrode in which portion the carbon film selective-growth region is to be formed, and then, removing the solvent while retaining the metal particles.

21. The method for the production of a cold cathode field emission device according to claim 16, in which the step for allowing the metal particles to adhere onto the surface of the portion of the cathode electrode in which portion the carbon film selective-growth region is to be formed comprises the steps of adhering metal compound particles containing metal atoms constituting the metal particles onto the surface of the portion of the cathode electrode in which portion the carbon film selective-growth region is to be formed, and then heating the metal compound particles to decompose them, whereby formed is the carbon film selective-growth region constituted of the portion of the cathode electrode which portion has the surface onto which the metal particles adhere.

22. The method for the production of a cold cathode field emission device according to claim 21, in which the step of allowing the metal particles to adhere onto the surface of the portion of the cathode electrode in which portion the carbon film selective-growth region is to be formed comprises the steps of forming a layer composed of a solvent and metal compound particles on the surface of the portion of the cathode electrode in which portion the carbon film selective-growth region is to be formed, and then removing the solvent while retaining the metal compound particles.

23. The method for the production of a cold cathode field emission device according to claim 21, in which the metal compound particles are composed of at least one material selected from the group consisting of halides, oxides and hydroxides of the metal constituting the metal particles.

24. The method for the production of a cold cathode field emission device according to claim 16, in which the metal particles are or the metal thin layer is composed of at least one metal selected from the group consisting of molybdenum, nickel, titanium, chromium, cobalt, tungsten, zirconium, tantalum, iron, copper, platinum, zinc, cadmium, mercury, germanium, tin, lead, bismuth, silver, gold, indium and thallium.

25. The method for the production of a cold cathode field emission device according to claim 16, in which the step of allowing the metal particles to adhere onto the surface of the portion of the cathode electrode in which portion the carbon film selective-growth region is to be formed comprises the step of sublimating a metal compound to deposit acicular metal particles composed of a metal constituting the metal compound on the surface of the portion of the cathode electrode in which portion the carbon film selective-growth region is to be formed.

26. The method for the production of a cold cathode field emission device according to claim 25, in which the acicular metal particles are composed of at least one metal selected from the group consisting of copper, iron, tungsten, tantalum, titanium and zirconium.

27. The method for the production of a cold cathode field emission device according to claim 16, in which the step of forming the organometallic compound thin layer on the surface of the portion of the cathode electrode in which portion the carbon film selective-growth region is to be formed comprises the step of forming a layer composed of an organometallic compound solution on the cathode electrode.

28. The method for the production of a cold cathode field emission device according to claim 27, in which the organometallic compound thin layer is composed of an organometallic compound containing at least one element selected from the group consisting of zinc, tin, aluminum, lead, nickel and cobalt.

29. The method for the production of a cold cathode field emission device according to claim 28, in which the organometallic compound thin layer is composed of a complex compound.

30. The method for the production of a cold cathode field emission device according to claim 16, in which the step of forming the organometallic compound thin layer on the surface of the portion of the cathode electrode in which portion the carbon film selective-growth region is to be formed comprises the step of sublimating an organometallic compound to deposit it on the cathode electrode.

31. The method for the production of a cold cathode field emission device according to claim 30, in which the organometallic compound thin layer is composed of an organometallic compound containing at least one element selected from the group consisting of zinc, tin, aluminum, lead, nickel and cobalt.

32. The method for the production of a cold cathode field emission device according to claim 31, in which the organometallic compound thin layer is composed of a complex compound.

33. The method for the production of a cold cathode field emission device according to claim 16, in which the step for forming the metal thin layer on the surface of the portion of the cathode electrode in which portion the carbon film selective-growth region is to be formed comprises a method of pyrolyzing an organometallic compound, a plating method, a chemical vapor deposition method or a physical vapor deposition method.

34. A method for the production of a cold cathode field emission device, comprising the steps of;
(A) forming a cathode electrode on a supporting substrate,
(B) forming a carbon film selective-growth region on a surface of the cathode electrode,
(C) forming a carbon film on the carbon film selective-growth region, and
(D) forming a gate electrode having an opening portion above the carbon film.

35. The method for the production of a cold cathode field emission device according to claim 34, in which the step (C) is followed by forming an insulating layer on the entire surface, and the step (D) is followed by forming, in the insulating layer, a second opening portion communicating the opening portion formed in the gate electrode and exposing the carbon film in a bottom portion of the second opening portion.

36. The method for the production of a cold cathode field emission device according to claim 34, in which the carbon film selective-growth region formation step comprises the step of allowing metal particles to adhere onto, or forming a metal thin layer or an organometallic compound thin layer on, the surface of a portion of the cathode electrode in which portion the carbon film selective-growth region is to be formed, whereby formed is the carbon film selective-growth region constituted of the portion of the cathode electrode which portion has the surface onto which the metal particles adhere or on which the metal thin layer or the organometallic compound thin layer is formed.

37. The method for the production of a cold cathode field emission device according to claim 36, further including the step of adhering sulfur, boron or phosphorus onto the surface of the carbon film selective-growth region.

38. The method for the production of a cold cathode field emission device according to claim 36, in which after the metal particles are allowed to adhere onto, or the metal thin layer or the organometallic compound thin layer is formed on, the surface of the cathode electrode, a metal oxide on the surface of each metal particle or on the surface of the metal thin layer or the organometallic compound thin layer is removed.

39. The method for the production of a cold cathode field emission device according to claim 38, in which the metal oxide on the surface of each metal particle or on the surface of the metal thin layer or the organometallic compound thin layer is removed by plasma reduction treatment or by washing.

40. The method for the production of a cold cathode field emission device according to claim 36, in which the step for allowing the metal particles to adhere onto the surface of a portion of the cathode electrode in which portion the carbon film selective-growth region is to be formed comprises the steps of forming a layer composed of a solvent and the metal particles on the surface of the portion of the cathode electrode in which portion the carbon film selective-growth region is to be formed, and then, removing the solvent while retaining the metal particles.

41. The method for the production of a cold cathode field emission device according to claim 36, in which the step for allowing the metal particles to adhere onto the surface of a portion of the cathode electrode in which portion the carbon film selective-growth region is to be formed comprises the steps of adhering metal compound particles containing metal atoms constituting the metal particles onto the surface of the portion of the cathode electrode in which portion the carbon film selective-growth region is to be formed, and then heating the metal compound particles to decompose them, whereby formed is the carbon film selective-growth region constituted of the portion of the cathode electrode which portion has the surface onto which the metal particles adhere.

42. The method for the production of a cold cathode field emission device according to claim 41, in which the step of allowing the metal particles to adhere onto the surface of a portion of the cathode electrode in which portion the carbon film selective-growth region is to be formed comprises the steps of forming a layer composed of a solvent and metal compound particles on the surface of the portion of the cathode electrode in which portion the carbon film selective-growth region is to be formed, and then removing the solvent while retaining the metal compound particles.

43. The method for the production of a cold cathode field emission device according to claim 41, in which the metal compound particles are composed of at least one material selected from the group consisting of halides, oxides and hydroxides of the metal constituting the metal particles.

44. The method for the production of a cold cathode field emission device according to claim 36, in which the metal particles are or the metal thin layer is composed of at least one metal selected from the group consisting of molybdenum, nickel, titanium, chromium, cobalt, tungsten, zirconium, tantalum, iron, copper, platinum, zinc, cadmium, mercury, germanium, tin, lead, bismuth, silver, gold, indium and thallium.

45. The method for the production of a cold cathode field emission device according to claim 36, in which the step of allowing the metal particles to adhere onto the surface of a portion of the cathode electrode in which portion the carbon film selective-growth region is to be formed comprises the step of sublimating a metal compound to deposit acicular metal particles composed of a metal constituting the metal compound on the surface of the portion of the cathode electrode in which portion the carbon film selective-growth region is to be formed.

46. The method for the production of a cold cathode field emission device according to claim 45, in which the acicular metal particles are composed of at least one metal selected from the group consisting of copper, iron, tungsten, tantalum, titanium and zirconium.

47. The method for the production of a cold cathode field emission device according to claim 36, in which the step of forming the organometallic compound thin layer on the surface of a portion of the cathode electrode in which portion the carbon film selective-growth region is to be formed comprises the step of forming a layer composed of an organometallic compound solution on the cathode electrode.

48. The method for the production of a cold cathode field emission device according to claim 47, in which the organometallic compound thin layer is composed of an organometallic compound containing at least one element selected from the group consisting of zinc, tin, aluminum, lead, nickel and cobalt.

49. The method for the production of a cold cathode field emission device according to claim 48, in which the organometallic compound thin layer is composed of a complex compound.

50. The method for the production of a cold cathode field emission device according to claim 36, in which the step of forming the organometallic compound thin layer on the surface of a portion of the cathode electrode in which portion the carbon film selective-growth region is to be formed comprises the step of sublimating an organometallic compound to deposit it on the cathode electrode.

51. The method for the production of a cold cathode field emission device according to claim 50, in which the organometallic compound thin layer is composed of an organometallic compound containing at least one element selected from the group consisting of zinc, tin, aluminum, lead, nickel and cobalt.

52. The method for the production of a cold cathode field emission device according to claim 51, in which the organometallic compound thin layer is composed of a complex compound.

53. The method for the production of a cold cathode field emission device according to claim 36, in which the step for forming the metal thin layer on the surface of a portion of the cathode electrode in which portion the carbon film selective-growth region is to be formed comprises a method of pyrolyzing an organometallic compound, a plating method, a chemical vapor deposition method or a physical vapor deposition method.

54. A method for the production of a cold cathode field emission device, comprising the steps of;
(A) forming a cathode electrode on a supporting substrate,
(B) forming a carbon film selective-growth region on a surface of the cathode electrode,
(C) forming a gate electrode having an opening portion above the carbon film selective-growth region, and
(D) forming a carbon film on the carbon film selective-growth region.

55. The method for the production of a cold cathode field emission device according to claim 54, in which the step (B) is followed by forming an insulating layer on the entire surface, and the step (C) is followed by forming, in the insulating layer, a second opening portion communicating the opening portion formed in the gate electrode and exposing the carbon film in a bottom portion of the second opening portion.

56. The method for the production of a cold cathode field emission device according to claim 54, in which the carbon film selective-growth region formation step comprises the step of allowing metal particles to adhere onto, or forming a metal thin layer or an organometallic compound thin layer on, the surface of a portion of the cathode electrode in which portion the carbon film selective-growth region is to be formed, whereby formed is the carbon film selective-growth region constituted of the portion of the cathode electrode which portion has the surface onto which the metal particles adhere or on which the metal thin layer or the organometallic compound thin layer is formed.

57. The method for the production of a cold cathode field emission device according to claim 56, further including the step of adhering sulfur, boron or phosphorus onto the surface of the carbon film selective-growth region.

58. The method for the production of a cold cathode field emission device according to claim 56, in which after the metal particles are allowed to adhere onto, or the metal thin layer or the organometallic compound thin layer is formed on, the surface of the cathode electrode, a metal oxide on the surface of each metal particle or on the surface of the metal thin layer or the organometallic compound thin layer is removed.

59. The method for the production of a cold cathode field emission device according to claim 58, in which the metal oxide on the surface of each metal particle or on the surface of the metal thin layer or the organometallic compound thin layer is removed by plasma reduction treatment or by washing.

60. The method for the production of a cold cathode field emission device according to claim 56, in which the step for allowing the metal particles to adhere onto the surface of a portion of the cathode electrode in which portion the carbon film selective-growth region is to be formed comprises the steps of forming a layer composed of a solvent and the metal particles on the surface of the portion of the cathode electrode in which portion the carbon film selective-growth region is to be formed, and then, removing the solvent while retaining the metal particles.

61. The method for the production of a cold cathode field emission device according to claim 56, in which the step for allowing the metal particles to adhere onto the surface of a portion of the cathode electrode in which portion the carbon film selective-growth region is to be formed comprises the steps of adhering metal compound particles containing metal atoms constituting the metal particles onto the surface of the portion of the cathode electrode in which portion the carbon film selective-growth region is to be formed, and then heating the metal compound particles to decompose them, whereby formed is the carbon film selective-growth region constituted of the portion of the cathode electrode which portion has the surface onto which the metal particles adhere.

62. The method for the production of a cold cathode field emission device according to claim 61, in which the step of allowing the metal particles to adhere onto the surface of a portion of the cathode electrode in which portion the carbon film selective-growth region is to be formed comprises the steps of forming a layer composed of a solvent and metal compound particles on the surface of the portion of the cathode electrode in which portion the carbon film selective-growth region is to be formed, and then removing the solvent while retaining the metal compound particles.

63. The method for the production of a cold cathode field emission device according to claim 61, in which the metal compound particles are composed of at least one material selected from the group consisting of halides, oxides and hydroxides of the metal constituting the metal particles.

64. The method for the production of a cold cathode field emission device according to claim 56, in which the metal particles are or the metal thin layer is composed of at least one metal selected from the group consisting of molybdenum, nickel, titanium, chromium, cobalt, tungsten, zirconium, tantalum, iron, copper, platinum, zinc, cadmium, mercury, germanium, tin, lead, bismuth, silver, gold, indium and thallium.

65. The method for the production of a cold cathode field emission device according to claim 56, in which the step of allowing the metal particles to adhere onto the surface of a portion of the cathode electrode in which portion the carbon film selective-growth region is to be formed comprises the step of sublimating a metal compound to deposit acicular metal particles composed of a metal constituting the metal compound on the surface of the portion of the cathode electrode in which portion the carbon film selective-growth region is to be formed.

66. The method for the production of a cold cathode field emission device according to claim 65, in which the acicular metal particles are composed of at least one metal selected from the group consisting of copper, iron, tungsten, tantalum, titanium and zirconium.

67. The method for the production of a cold cathode field emission device according to claim 56, in which the step of forming the organometallic compound thin layer on the surface of a portion of the cathode electrode in which portion the carbon film selective-growth region is to be formed comprises the step of forming a layer composed of an organometallic compound solution on the cathode electrode.

68. The method for the production of a cold cathode field emission device according to claim 67, in which the organometallic compound thin layer is composed of an organometallic compound containing at least one element selected from the group consisting of zinc, tin, aluminum, lead, nickel and cobalt.

69. The method for the production of a cold cathode field emission device according to claim 68, in which the organometallic compound thin layer is composed of a complex compound.

70. The method for the production of a cold cathode field emission device according to claim 56, in which the step of forming the organometallic compound thin layer on the surface of a portion of the cathode electrode in which portion the carbon film selective-growth region is to be formed comprises the step of sublimating an organometallic compound to deposit it on the cathode electrode.

71. The method for the production of a cold cathode field emission device according to claim 70, in which the organometallic compound thin layer is composed of an organometallic compound containing at least one element selected from the group consisting of zinc, tin, aluminum, lead, nickel and cobalt.

72. The method for the production of a cold cathode field emission device according to claim 71, in which the organometallic compound thin layer is composed of a complex compound.

73. The method for the production of a cold cathode field emission device according to claim 56, in which the step for forming the metal thin layer on the surface of a portion of the cathode electrode in which portion the carbon film selective-growth region is to be formed comprises a method of pyrolyzing an organometallic compound, a plating method, a chemical vapor deposition method or a physical vapor deposition method.

74. A cold cathode field emission display comprising a plurality of pixels,
each pixel comprising a cold cathode field emission device, an anode electrode and a fluorescent layer, the anode electrode and the fluorescent layer being formed on a substrate so as to be opposed to the cold cathode field emission device, and
the cold cathode field emission device comprising;
(a) a conductive layer with a carbon film selective-growth region formed on a surface thereof, and
(b) an electron emitting portion composed of a carbon film formed on the carbon film selective-growth region.

75. A cold cathode field emission display comprising a plurality of pixels,
each pixel comprising a cold cathode field emission device, an anode electrode and a fluorescent layer, the anode electrode and the fluorescent layer being formed on a substrate so as to be opposed to the cold cathode field emission device, and
the cold cathode field emission device comprising;
(a) a cathode electrode formed on a supporting substrate, and
(b) a gate electrode which is formed above the cathode electrode and has an opening portion,
and further comprising;
(c) an electron emitting portion composed of a carbon film formed on a surface of a portion of the cathode electrode which portion is positioned in a bottom portion of the opening portion.

76. A cold cathode field emission display comprising a plurality of pixels,
each pixel comprising a cold cathode field emission device, an anode electrode and a fluorescent layer, the anode electrode and the fluorescent layer being formed on a substrate so as to be opposed to the cold cathode field emission device, and
the cold cathode field emission device comprising;
(a) a cathode electrode formed on a supporting substrate,
(b) a gate electrode which is formed above the cathode electrode and has an opening portion,
(c) a carbon film selective-growth region formed at least on a surface of a portion of the cathode electrode which portion is positioned in a bottom portion of the opening portion, and
(d) an electron emitting portion composed of a carbon film formed on the carbon film selective-growth region.

77. A method for the production of a cold cathode field emission display, comprising arranging a substrate having an anode electrode and a fluorescent layer formed thereon and a supporting substrate having a cold cathode field emission device formed thereon, such that the fluorescent layer and the cold cathode field emission device are opposed to each other, and bonding the substrate and the supporting substrate in circumferential portions thereof,
wherein the cold cathode field emission device is produced by a method comprising the steps of;
(A) forming a cathode electrode on a supporting substrate,
(B) forming an insulating layer on the supporting substrate and the cathode electrode,
(C) forming a gate electrode having an opening portion on the insulating layer,
(D) forming, in the insulating layer, a second opening portion communicating with the opening portion formed in the gate electrode,
(E) forming a carbon film selective-growth region on a surface of a portion of the cathode electrode which portion is positioned in a bottom portion of the second opening portion, and
(F) forming a carbon film on the carbon film selective-growth region.

78. A method for the production of a cold cathode field emission display, comprising arranging a substrate having an anode electrode and a fluorescent layer formed thereon and a supporting substrate having a cold cathode field emission device formed thereon, such that the fluorescent layer and the cold cathode field emission device are opposed to each other, and bonding the substrate and the supporting substrate in circumferential portions thereof,
wherein the cold cathode field emission device is produced by a method comprising the steps of;
(A) forming a cathode electrode on a supporting substrate,
(B) forming a carbon film selective-growth region on a surface of the cathode electrode,
(C) forming a carbon film on the carbon film selective-growth region, and
(D) forming a gate electrode having an opening portion above the carbon film.

79. A method for the production of a cold cathode field emission display, comprising arranging a substrate having an anode electrode and a fluorescent layer formed thereon and a supporting substrate having a cold cathode field emission device formed thereon, such that the fluorescent layer and the cold cathode field emission device are opposed to each other, and bonding the substrate and the supporting substrate in circumferential portions thereof,
wherein the cold cathode field emission device is produced by a method comprising the steps of;
(A) forming a cathode electrode on a supporting substrate,
(B) forming a carbon film selective-growth region on a surface of the cathode electrode,
(C) forming a gate electrode having an opening portion above the carbon film selective-growth region, and
(D) forming a carbon film on the carbon film selective-growth region.
